(19) United States
(12) Patent Application Publication
(10) Pub. No.: US 2024/0198203 A1
(43) Pub. Date: Jun. 20, 2024

(54) RECREATIONAL GAME AND SPORTING EVENT MANAGEMENT APPLICATION

(71) Applicant: Sports Matching Corp., Gladwyne, PA (US)

(72) Inventor: Alex Berger, Gladwyne, PA (US)

(73) Assignee: Sports Matching Corp., Gladwyne, PA (US)

(21) Appl. No.: 18/537,117

(22) Filed: Dec. 12, 2023

Related U.S. Application Data
(60) Provisional application No. 63/476,062, filed on Dec. 19, 2022.

(51) Int. Cl. A63B 71/06; G06Q 20/42; G06Q 50/34; G07F 17/32

(52) U.S. Cl. CPC A63B 71/0616; G06Q 20/42; G06Q 50/34; G07F 17/3288

(57) ABSTRACT

The present invention is direct to an application for managing and organizing recreational activities and sporting events in order to provide users with a platform to foster a community of players. Additionally, the application includes a matchmaking feature to match users with similar recreational interests together, a safety feature to gauge the relative safety of a location, a wager feature to allow users to place bets on variables associated with events managed through the platform, and a coaching feature to allow users to match with trainers to increase their skills in particular recreational activities and sports.

### CROSS REFERENCES TO RELATED APPLICATIONS

This application is related to and claims priority from the following U.S. patent application. This application claims priority to and the benefit of U.S. Provisional Patent Application No. 63/476,062, filed Dec. 19, 2022, which is incorporated herein by reference in its entirety.

### BACKGROUND OF THE INVENTION

### 1. Field of the Invention

The present invention relates to an application for managing recreational activities and sporting events to allow players to connect with one another in order to participate in recreational activities and sporting events, more specifically to a social platform for connecting athletes, coaches, participants, and spectators together to interact and organize sporting events.

### 2. Description of the Prior Art

It is generally known in the prior art to provide a sports management system for connecting users to play recreational sports and to provide a social network for users to interact with one another.

U.S. Pat. No. 9,087,320 for a sports collaboration and communication platform by inventors Goldman, et al., filed Sep. 15, 2010 and issued Jul. 21, 2015, is directed to a sports management system that provides a platform and social network for those associated with youth and other sports to simplify common tasks, unify related participants, and enhance the activities surrounding playing sports. The system brings together players, parents, and coaches into an integrated experience centered on the information each is interested in. The system is not tied to any one sport, but rather can unify information from multiple sports, so families that have multiple children playing, for example, soccer, football, basketball, and baseball can follow information about their players and teams throughout the year. Thus, the sports management system provides a one-stop location for all parties related to youth and other sports to gather and share information.

U.S. Patent Publication No. 2016/0350722 for managing scheduled events in network-hosted time management system by inventors Walker, et al., filed Jan. 23, 2015 and published Dec. 1, 2016, is directed to methods, apparatuses, and computer readable media that manage scheduled events in network-hosted time management system. Reusable non-user-specific templates, including event, notification, and associated data record stored in network-accessible database, are constructed. At least one rule is included in each template that creates temporal relationship between at least two events, or event and associated data record. Templates are instantiated by populating records with data to create a user-specific event schedule, or multiple role roster. Event notification alert temporal data is monitored, and a user device is notified by initiating a smart alert that includes a notification regarding event in a schedule requiring a reply from user device with information to satisfy the rule associated with the smart-alert. The user device receives a reply to the smart-alert to update associated data record. Based on change to data in a data record, the rule, event, data record, role and/or notification is changed.

U.S. Pat. No. 8,832,301 for a system and method for enhanced event participation by inventors Graff, et al., filed Mar. 15, 2013 and issued Sep. 9, 2014, is directed to a computer-based system for enhanced communications and event management that focuses on customization of the event attendee experience. Each event attendee is provided with the tools necessary to effectively and efficiently create an event experience that most closely matches their goals and objectives. For example, a variety of dynamic event activity maps provide event attendees with the ability to quickly and easily identify and locate the most interesting and pertinent seminars, classes, speakers, vendors, exhibitors, etc. Additionally, event attendees can update and control their event schedule, customize communications that are sent and received, set up meetings with other event attendees, and receive updates about event activities and schedules. Vendors, exhibitors, and event organizers are provided with a series of tools, including “gamification” tools, that will allow them engage event attendees in event activities to increase attendee participation.

U.S. Patent Publication No. 2009/0099924 for a system and method for creating a team sport community by inventors Lensch, et al., filed Sep. 29, 2008 and published Apr. 16, 2009, is directed to systems and methods for creating a team sport community including organizing a sporting event for a team sport. More specifically, a team sport may be selected from a plurality of team sports and a team having a plurality of positions may be assembled to participate in the team sporting event. One or more players may be associated with each position on the team. Each player may have a player profile that describes player information such as a player's name, games scheduled for the player, and the player's statistics. A player may create a sporting event for a team and may also search for a sporting event in which to play as an individual player or as a position on a team. A player may also search for a sporting event by the location of the sporting event and obtain information about the location, time, teams, and players associated with the sporting event.

U.S. Patent Publication No. 2008/0222535 for a sports matchmaker system by inventors Zrike, et al., filed Mar. 12, 2008 and published Sep. 11, 2008, is directed to an improved method for arranging sporting events and non-sporting events between unacquainted people. It provides a system for matching persons publicly offering to participate in particular sporting or social events with other persons desiring to participate in similar sporting or social events. The system also provides various means for communicating between the offering party and the accepting party to complete the event. The system also provides methods for arranging event venues for sporting and social events.

### SUMMARY OF THE INVENTION

The present invention relates to an application and platform to facilitate organization and management of recreational activities and sporting events while fostering an online community.

It is an object of this invention to provide an application for users to manage and organize recreational activities and sporting events while providing a platform for users to socialize and interact. It is another object of this invention to provide a proximity-defined interface to visualize local sporting events managed through the application, a safety feature to gauge the relative safety of a location, a coaching feature to facilitate training sessions, and a wager feature to place bets on events involving activities managed through the platform.

In one embodiment, the present invention is directed towards a system for matching sports event hosts and players, including a server platform, including a processor and a memory, in network communication with a plurality of user devices, wherein the server platform is operable to generate user profiles for each user based on inputs from the plurality of user devices, the user profiles including preference data and at least one associated geolocation, wherein the server platform is operable to update the user profiles with game statistics from previous sporting events, wherein the server platform is operable to receive commands from one or more event host user profiles to generate one or more sporting events, and wherein each of the one or more sporting events are associated with a geolocation and a time, wherein the server platform is operable to generate a feed of relevant past and upcoming events for each user profile based on the preference data and the at least one associated geolocation of the user profile, and the geolocation associated with the past and upcoming events, wherein the server platform includes a query module configured to receive search criteria input from the plurality of user devices and return a list of sporting events relevant to the search criteria input, wherein the server platform is configured to receive requests from player user profiles to join the one or more sporting events, wherein the server platform transmits a notification to the one or more event host user profiles regarding the requests to join the one or more sporting events, wherein the server platform is only able to receive the requests to join the one or more sporting events if the player user profiles meet one or more preestablished requirements associated with the one or more sporting events, wherein the server platform is operable to generate a map interface on the plurality of user devices, wherein the geolocations associated with the one or more sporting events are visually overlaid on the map interface, and wherein the server platform includes a wager module, wherein the wager module is operable to receive wager criteria corresponding to one or more wagers relating to the one or more sporting events and automatically generate smart contracts enforcing transfer of funds between two or more wagering user profiles upon when the wager criteria are met.

In another embodiment, the present invention is directed towards a method for matching sports event hosts and players, including a server platform generating user profiles for users based on inputs from a plurality of user devices, the user profiles including preference data and at least one associated geolocation, the server platform updating user profiles with game statistics from previous sporting events, the server platform receiving commands from one or more event host user profiles to generate one or more sporting events, and wherein each of the one or more sporting events are associated with a geolocation and a time, the server platform generating a feed of relevant past and upcoming events for each user profile based on the preference data and the at least one associated geolocation of the user profile, and the geolocation associated with the past and upcoming events, a query module of the server platform receiving search criteria input from the plurality of user devices and returning a list of sporting events relevant to the search criteria input, the server platform receiving requests from player user profiles to join the one or more sporting events, the server platform transmitting notifications to the one or more event host user profiles regarding the requests to join the one or more sporting events, the server platform receiving the requests to join the one or more sporting events only if the player user profiles meet one or more preestablished requirements associated with the one or more sporting events, the server platform generating a map interface on the plurality of user devices, wherein the geolocations associated with the one or more sporting events are visually overlaid on the map interface, and a wager module of the server platform receiving wager criteria corresponding to one or more wagers relating to the one or more sporting events and automatically generating smart contracts enforcing transfer of funds between two or more wagering user profiles upon when the wager criteria are met.

In yet another embodiment, the present invention is directed towards a system for matching sports event hosts and players, including a server platform, including a processor and a memory, in network communication with a plurality of user devices, wherein the server platform is operable to generate user profiles for each user based on inputs from the plurality of user devices, the user profiles including preference data and at least one associated geolocation, wherein the server platform is operable to update the user profiles with game statistics from previous sporting events, wherein the server platform is operable to receive commands from one or more event host user profiles to generate one or more sporting events, and wherein each of the one or more sporting events are associated with a geolocation and a time, wherein the server platform is operable to receive commands from one or more coach profiles to generate one or more coaching events, and wherein each of the one or more coaching events are associated with a geolocation and a time, wherein the server platform is operable to generate a feed of relevant past and upcoming events for each user profile based on the preference data and the at least one associated geolocation of the user profile, and the geolocation associated with the past and upcoming events, wherein the server platform includes a query module configured to receive search criteria input from the plurality of user devices and return a list of sporting events relevant to the search criteria input, wherein the server platform is configured to receive requests from player user profiles to join the one or more sporting events, wherein the server platform is configured to receive requests from player user profiles to join the one or more coaching events, wherein the server platform transmits a notification to the one or more event host user profiles regarding the requests to join the one or more sporting events, wherein the server platform is only able to receive the requests to join the one or more sporting events if the player user profiles meet one or more preestablished requirements associated with the one or more sporting events, and wherein the server platform is operable to generate a map interface on the plurality of user devices, wherein the geolocations associated with the one or more sporting events are visually overlaid on the map interface.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a graphical user interface (GUI) for a login menu according to one embodiment of the present invention.

FIG. 2 illustrates a GUI for an account creation menu according to one embodiment of the present invention.

FIG. 3 illustrates a GUI for a user profile according to one embodiment of the present invention.

FIG. 4 illustrates a GUI for a player profile according to one embodiment of the present invention.

FIG. 5 illustrates a GUI for a social post creation menu according to one embodiment of the present invention.

FIG. 6 illustrates a GUI for a host-a-game creation menu according to one embodiment of the present invention.

FIG. 7 illustrates a GUI for a social media feed according to one embodiment of the present invention.

FIG. 8 illustrates a GUI for a joined game menu according to one embodiment of the present invention.

FIG. 9 illustrates a GUI for a detailed joined game menu according to one embodiment of the present invention.

FIG. 10 illustrates a GUI for a proximity-defined game map interface according to one embodiment of the present invention.

FIG. 11 illustrates a GUI for a notification menu according to one embodiment of the present invention.

FIG. 12 is a schematic diagram of a system of the present invention.

### DETAILED DESCRIPTION

The present invention is generally directed to an application for managing and organizing recreational activities and sporting events. The application is operable to provide a platform for fostering a community of users by implementing social, geo-location, safety, betting, and coaching features to create an all-encompassing, interactive, recreational activity experience.

In one embodiment, the present invention is directed towards a system for matching sports event hosts and players, including a server platform, including a processor and a memory, in network communication with a plurality of user devices, wherein the server platform is operable to generate user profiles for each user based on inputs from the plurality of user devices, the user profiles including preference data and at least one associated geolocation, wherein the server platform is operable to update the user profiles with game statistics from previous sporting events, wherein the server platform is operable to receive commands from one or more event host user profiles to generate one or more sporting events, and wherein each of the one or more sporting events are associated with a geolocation and a time, wherein the server platform is operable to generate a feed of relevant past and upcoming events for each user profile based on the preference data and the at least one associated geolocation of the user profile, and the geolocation associated with the past and upcoming events, wherein the server platform includes a query module configured to receive search criteria input from the plurality of user devices and return a list of sporting events relevant to the search criteria input, wherein the server platform is configured to receive requests from player user profiles to join the one or more sporting events, wherein the server platform transmits a notification to the one or more event host user profiles regarding the requests to join the one or more sporting events, wherein the server platform is only able to receive the requests to join the one or more sporting events if the player user profiles meet one or more preestablished requirements associated with the one or more sporting events, wherein the server platform is operable to generate a map interface on the plurality of user devices, wherein the geolocations associated with the one or more sporting events are visually overlaid on the map interface, and wherein the server platform includes a wager module, wherein the wager module is operable to receive wager criteria corresponding to one or more wagers relating to the one or more sporting events and automatically generate smart contracts enforcing transfer of funds between two or more wagering user profiles upon when the wager criteria are met.

In another embodiment, the present invention is directed towards a method for matching sports event hosts and players, including a server platform generating user profiles for users based on inputs from a plurality of user devices, the user profiles including preference data and at least one associated geolocation, the server platform updating user profiles with game statistics from previous sporting events, the server platform receiving commands from one or more event host user profiles to generate one or more sporting events, and wherein each of the one or more sporting events are associated with a geolocation and a time, the server platform generating a feed of relevant past and upcoming events for each user profile based on the preference data and the at least one associated geolocation of the user profile, and the geolocation associated with the past and upcoming events, a query module of the server platform receiving search criteria input from the plurality of user devices and returning a list of sporting events relevant to the search criteria input, the server platform receiving requests from player user profiles to join the one or more sporting events, the server platform transmitting notifications to the one or more event host user profiles regarding the requests to join the one or more sporting events, the server platform receiving the requests to join the one or more sporting events only if the player user profiles meet one or more preestablished requirements associated with the one or more sporting events, the server platform generating a map interface on the plurality of user devices, wherein the geolocations associated with the one or more sporting events are visually overlaid on the map interface, and a wager module of the server platform receiving wager criteria corresponding to one or more wagers relating to the one or more sporting events and automatically generating smart contracts enforcing transfer of funds between two or more wagering user profiles upon when the wager criteria are met.

In yet another embodiment, the present invention is directed towards a system for matching sports event hosts and players, including a server platform, including a processor and a memory, in network communication with a plurality of user devices, wherein the server platform is operable to generate user profiles for each user based on inputs from the plurality of user devices, the user profiles including preference data and at least one associated geolocation, wherein the server platform is operable to update the user profiles with game statistics from previous sporting events, wherein the server platform is operable to receive commands from one or more event host user profiles to generate one or more sporting events, and wherein each of the one or more sporting events are associated with a geolocation and a time, wherein the server platform is operable to receive commands from one or more coach profiles to generate one or more coaching events, and wherein each of the one or more coaching events are associated with a geolocation and a time, wherein the server platform is operable to generate a feed of relevant past and upcoming events for each user profile based on the preference data and the at least one associated geolocation of the user profile, and the geolocation associated with the past and upcoming events, wherein the server platform includes a query module configured to receive search criteria input from the plurality of user devices and return a list of sporting events relevant to the search criteria input, wherein the server platform is configured to receive requests from player user profiles to join the one or more sporting events, wherein the server platform is configured to receive requests from player user profiles to join the one or more coaching events, wherein the server platform transmits a notification to the one or more event host user profiles regarding the requests to join the one or more sporting events, wherein the server platform is only able to receive the requests to join the one or more sporting events if the player user profiles meet one or more preestablished requirements associated with the one or more sporting events, and wherein the server platform is operable to generate a map interface on the plurality of user devices, wherein the geolocations associated with the one or more sporting events are visually overlaid on the map interface.

None of the prior art discloses a recreational and sport organizing platform that implements a safety feature, a wager feature, and proximity-defined functionality as described in the present application.

Recreational activities and sporting events are any form of competitive physical and/or mental activity or game that aim to improve physical and/or mental ability and skill while providing enjoyment to its participants and spectators. Recreational games and sporting events are deeply engrained in human history and culture. A wide range of sports and recreational games were established even in ancient civilizations, such as Ancient Greece (in addition to other ancient cultures), where sports became such a prominent part of Greek culture that the Olympic Games were created. While many sports and recreational activities can be categorized as individual in nature (e.g., golf, running, swimming, climbing, archery, bicycling etc.), even these sports require an opponent or a partner, while a majority of sports require participation from a multitude of individuals aligned in teams to be played.

Team-oriented sports and recreational activities are among the most popular human past times due to the comradery, entertainment, and enjoyment procured by participating in and spectating them. However, in order to play a team-oriented sport and solo sports that require an opponent, players must find other individuals able and willing to participate. This proves to be difficult for many players. Factors that lend to this difficulty include: geography, participation age, participation preference, participant physical attributes, participant skill and experience, scheduling conflicts, social anxiety, weather, equipment availability, and/or safety concerns. Additionally, players often have their own recreational preferences they would like to see mimicked in their team and opposing teams (e.g., gender, skill level, age, sporting category, competitive level, etc.).

Furthermore, while players are technically able to go knocking door-to-door or posting flyers for an upcoming game, this is time consuming, inefficient, and sometimes even dangerous. Additionally, players need a platform to communicate with each other in the event of changed circumstances and to ensure the game is planned accordingly. Additionally, organizing a recreation activity or sport requires coordination of a multitude of factors. Organizers need to know and share the game's location, time, sport type, participants, predicted length, and other information required to ensure the recreational activity goes as planned. While the prior art discloses social platforms for individuals to interact, many of platforms are not tailored to the recreational activity and sporting event field and include shortcomings that fail to refine the sports matchmaking experience.

The addition of features not found in prior art are necessary to refine the sports matchmaking experience. The inclusion of a safety feature, designed to allow users to place a rating on the locations, fields, or courts that they play on. Compiling these ratings over time allows any user to view the relative safety of a proposed recreational sport location. The inclusion of a proximity feature through Global Position Systems (GPS) allows players to view hosted games in their general area. The inclusion of a coach matchmaking features, allows users to not only search for game participates, but also for mentors to help increase their skills in their desired sport. Lastly, the inclusion of a wager features allows users, participants, and spectators to place bets on the scoring, outcome, or statistics associated with a game managed through the platform. All of these additional features help to refine the sports matchmaking experience and prove useful to a community of recreational players.

Therefore, there is a need for a platform to facilitate managing and organizing recreational activities and sporting events that allows uses to connect and interact with each other while integrating social, organizational, safety, wager, and, proximity conscious features to create an all-encompassing sports matchmaking experience.

The present invention includes a recreational games matchmaking application. The application is representative of a social, business, and/or administrative platform that facilitates recreational activities and sporting event communities.

In one embodiment, the application is operable on any mobile device known in the art, including but not limited to smart phones, mobile phones, laptop computers, tablets, phablets, etc. The mobile device running the application of the present invention is in network communication with at least one server computer including a processor and a memory. Application data for the mobile application running on the mobile device is preferably stored on one or more databases of the server computer and/or on the mobile device itself. Alternatively, application data is stored on the cloud or on edge nodes.

The application of the present invention is preferably installed on the mobile device. Alternatively, the application is a web-browser based application operable to be accessed through a web browser running on the mobile device.

In one embodiment, the application of the present invention is operable to communicate with a plurality of sensors incorporated in the user device running the application. In one embodiment, the application of the present invention is operable to communicate with one or more of the following: Global Positioning System (GPS) sensor, camera, LiDAR sensor, Quick Response (QR) code scanner, bar code scanner, accelerometer, gyroscope, Ultra-wideband (UWB) transmitter, Radio-frequency Identification Chip (RFID), Near-Field Communication (NFC) chip, and other similar sensors known in the art.

Referring now to the drawings in general, the illustrations are for the purpose of describing one or more preferred embodiments of the invention and are not intended to limit the invention thereto.

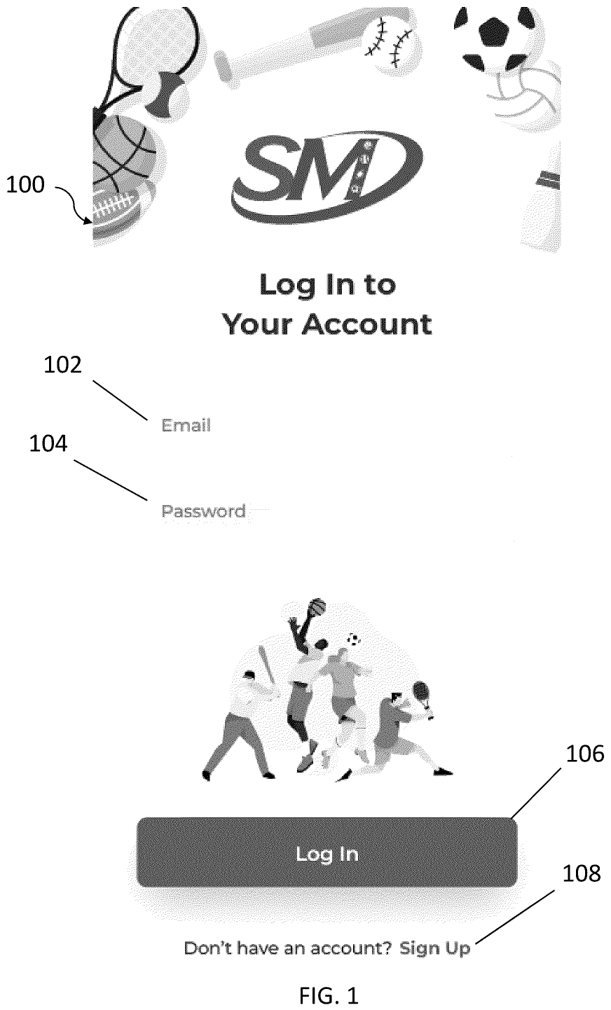

FIG. 1 illustrates a Graphical User Interface (GUI) for a login menu 100 according to one embodiment of the present invention. Specifically, FIG. 1 includes a login menu 100 page, an email field 102, a password field 104, a login button 106, and a sign-up button 108. The login menu 100 serves as a starting page to allow users to either login to an already existing account or be transferred to a page that allows them to create an account. In one embodiment, the GUI is operable to receive input from a user to associate with a user profile. Once a user has logged in, the user device has access to data associated with a user profile and features of the application of the present invention. The email field 102 is operable to receive text input that represents the user's email and acts as a credential required for login. The password field 104 is operable to receive a typed code or word to act as a secret password to allow a user to login to their account or user profile. In one embodiment, the login credentials (e.g., a user's email and password) are stored on a database, cloud server, blockchain, or any other data storage technology known in the art. Once both the email field 102 and the password field 104 have been filled with account credentials, the login button 106 is operable to cause the GUI of the mobile device to load a page corresponding to another page of the application to access the features of the platform.

Alternatively, login is performed using biometric information such as fingerprints obtained through a fingerprint scanner of the mobile device or biometric information obtained through a camera of the mobile device such as facial recognition, iris recognition, or retina recognition. The sign-up bottom 108 is operable to cause the GUI of the mobile device to load a page corresponding to an account creation page 120.

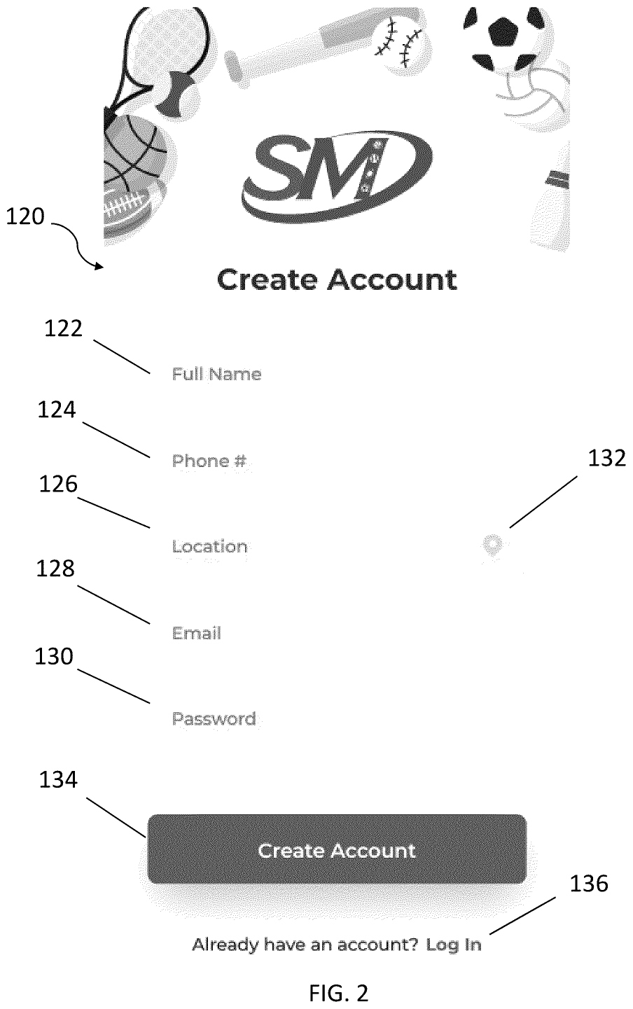

FIG. 2 illustrates a GUI for an account creation menu 120 according to one embodiment of the present invention. Specifically, FIG. 2 includes a full name field 122, a phone number field 124, a user location field 126, an email field 128, a password field 130, an account creation button 134, an auto-fill location button 132, and a login button 136. The account creation menu 120 serves as another starting point that allows users to input information necessary to create an account to access the features of the application and to associate information input into the application with a user. The full name field 122 is operable to receive text input of the name of the individual who desires to create an account. The phone number field 124 is operable to receive text input of the phone number of the individual who desires to create an account. In one embodiment, the phone number field 124 is operable to notify the user when an incorrect phone number has been input (i.e., a sequence of numbers that do not amount to a standard phone number code).

In one embodiment, the user location field 126 is operable to receive text input of the location of the individual who desires to create an account. In one embodiment, the user location field 126 is operable to be automatically filled using location data derived from a GPS unit or other similar geo-location sensitive device known in the art. The auto-fill location button 132 is operable cause the GUI of the mobile device to input the current location of the user or user device into the user location field 126. In one embodiment, the auto-fill location button 132 operates based on geo-location data generated by a GPS chip or other geo-location sensitive device to determine the current location of the user.

The email field 128 is operable to receive text input of the email associated with the user account. In one embodiment, the email field 128 is operable to notify the user when an incorrect email format or a nonexistent email has been input. The password field 130 is operable to receive text input of a password to associate with the user account. In one embodiment, the password field 130 is operable to require a number of pre-requisites before accepting an input password (i.e., requiring at least a special character, capital letter, or number). In one embodiment, the password field 130 is operable to cause the GUI of the mobile device to notify the user of any deficiency in the password field 130 input. In one embodiment, the application of the present invention is operable to cause the GUI of the mobile device to send a notification to a user device to notify a user of a deficiency in the full name field 122, the phone number field 124, the user location field 126, the email field 128, or the password field 130 via a push-notification, pop-up notification, text message, email, phone call, or other notifying message known in the art.

The create account button 134 is operable to cause the GUI of the mobile device to display a confirmation message on a user device to indicate that an account was successfully created. In one embodiment, the create account button 134 is operable to cause the application to receive and save the input placed in the full name field 122, the phone number field 124, the user location field 126, the email field 128, and the password field 130 to a database, cloud platform, blockchain, or other similar data storage technology known in the art, such that the information is associated with a user account and is able to be input at a later time to allow the user to login to the application. The login button 136 is operable to cause the GUI of the mobile device to return to the account login page 100.

In one embodiment, all fields are required to receive text input in order to create an account. In one embodiment, only a select number of fields are required to receive input in order to create an account. In one embodiment, where a required field fails to receive input, the GUI of the mobile device is operable to indicate what field requires input through a prompt, message, notification, or by highlighting the required field.

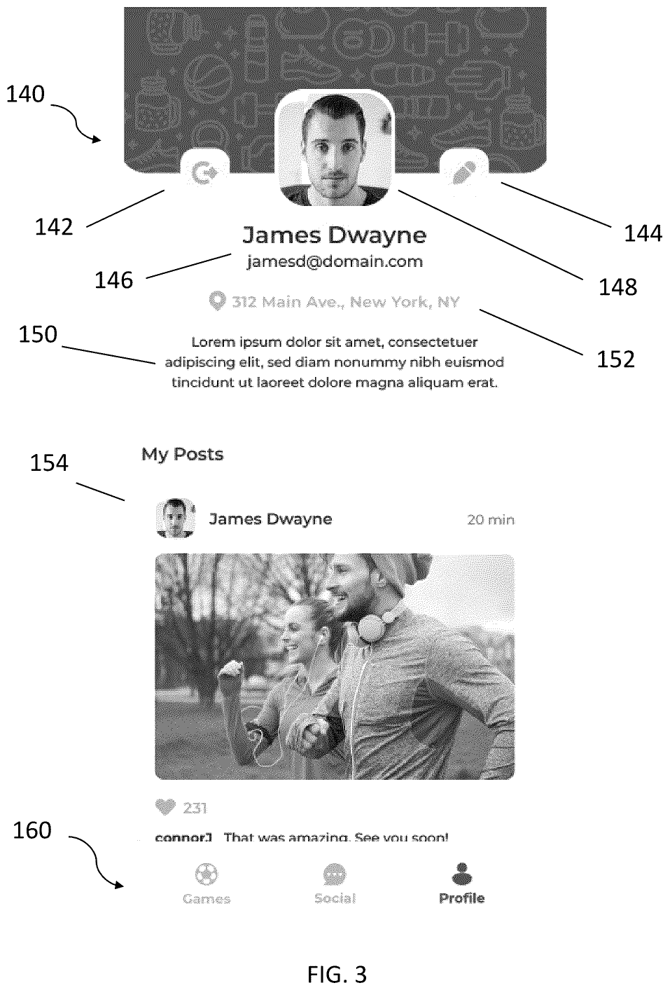

FIG. 3 illustrates a GUI for a user profile page 140 according to one embodiment of the present invention. The user profile page 140 is representative of a profile page that includes relevant personal information about the user. The user profile page 140 is representative of the information a user would like to share with other users of the platform.

Specifically, FIG. 3 includes a share profile button 142, an edit profile button 144, a personal information field 146, a user profile picture 148, a personal biography field 150, a location field 152, a personal social feed 154, and navigation tab buttons 160.

The GUI of FIG. 3 includes a user profile picture 148 that is a representative illustration or photograph of the user. In a preferred embodiment, the user profile picture 148 contains a photograph of the user. The GUI of FIG. 3 includes a personal information field 146 that displays the user's name, contact information, and/or other relevant identifying information. The GUI of FIG. 3 includes a personal biography field 150 that is operable to display text to the user device of anyone viewing the user profile page 140. In a preferred embodiment, a personal biography related to the recreational activities of interest is contained in the personal biography field 150, although the personal biography field 150 is operable to receive and display any text input. The GUI of FIG. 3 includes a location field 152 that displays information related to the user's current geographic location and/or a home location of the user. In a preferred embodiment, the location field 152 includes the personal residence, the general area, or the area of recreational interested to the user (i.e., where they intended to play sports). The GUI of FIG. 3 includes a personal social feed 154 that displays recent social posts, recreational game posts, or other general activity posted by the user as a scrolling list. The personal social feed 154 includes all of the user's activity related to the application. The social feed will be discussed in more detail below.

In one embodiment, the GUI of FIG. 3 includes a plurality of navigation tab buttons 160. In one embodiment, the GUI of FIG. 3 includes a user profile tab button, a social feed tab button, and a games tab button. In one embodiment, the user profile tab button, social feed tab button, and the games tab button are included in the GUI of one, all, or a select number of GUI pages and/or interfaces. In one embodiment, the profile tab button, the social feed tab button, and the games tab button are operable as navigation tab buttons, such that selection of the tab buttons causes the GUI to load a page corresponding to different pages and interfaces of the application. In one embodiment, one, all, or a select number of GUI pages include a plurality of navigation tab buttons that are operable to cause the GUI to load any of the GUI pages of the application. In one embodiment, the GUI of FIG. 3 includes navigation tab buttons 160 that are operable to load a plurality of pages on the user device.

In one embodiment, the GUI of FIG. 3 includes a user profile tab button that, upon selection, is operable to cause the GUI to load the user profile page 140. In one embodiment, the GUI of FIG. 3 includes a social feed tab button and a games tab button that function similar to the user profile tab button. In one embodiment, upon selection, the social feed tab button is operable to cause the GUI to load a page corresponding to a social feed page and the games tab button is operable to cause the GUI to load a page corresponding to a proximity-defined game map interface. The user profile tab button, social feed tab button, and the games tab button allow the user, through the GUI of the user device, to easily navigate the different functionalities and features of the application in an organized manner.

The edit profile button 144 is operable to cause the GUI of the mobile device to display text input boxes that allow the user to edit the information included in the personal information field 146, the user profile picture 148, the personal biography field 150, and/or the location field 152. Additionally, the edit profile button 144 is operable to allow the user to edit or delete content on the personal social feed 154 through the GUI of the user device.

The share profile button 142 is operable to cause the GUI of the user device to display an interface with share profile options that allows a user to share their user profile. In one embodiment, the share profile button 142 is operable to create a link to the user's profile. In one embodiment, the share profile button 142 is operable share the user's profile with other social media platforms.

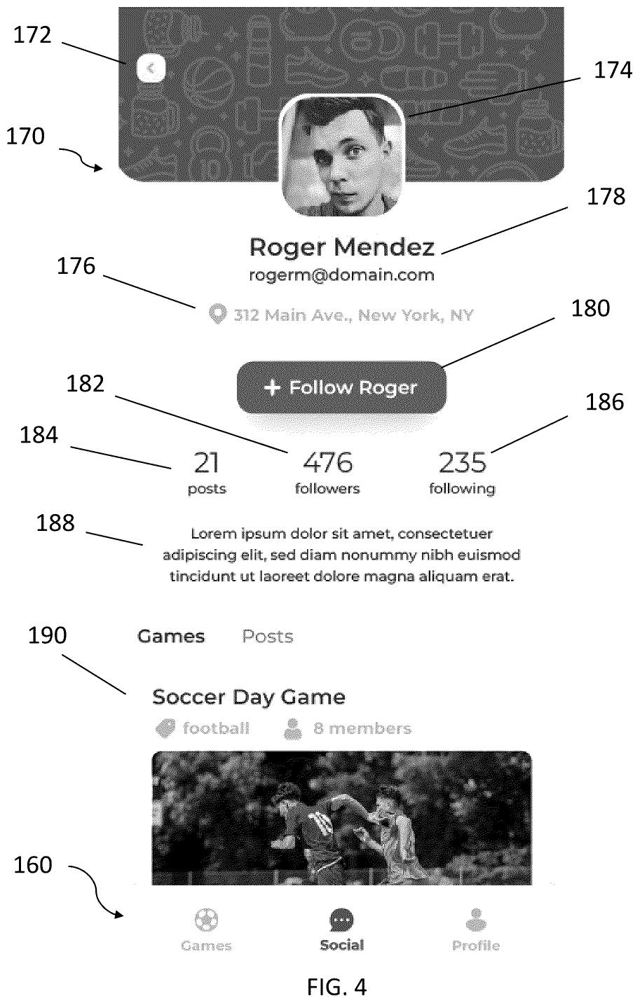

FIG. 4 illustrates a GUI for a player profile page 170 according to one embodiment of the present invention. The player profile page 170 is similar to the user profile page 140 in that it displays personal information about a user, but the player profile page 170 represents a different user's (Player's) personal information. FIG. 4 illustrates a GUI of player's profile page 140. FIG. 4 illustrates a GUI of what a user will see when they view another user's profile page. FIG. 4 illustrates the GUI of another user's profile page (i.e., the profile page of a different user than the one viewing the page). Specifically, the GUI of FIG. 4 includes the player profile page 170, a return button 172, a player profile picture 174, a player location field 176, a player information field 178, a follow player button 180, a followers field 182, a number of posts field 184, a following field 186, a player biography field 188, a player social feed 190, and the navigation tab buttons 160 discussed above.

In one embodiment, the return button 172 is operable, upon click selection, to cause the GUI to load a page corresponding to the page that was previously loaded prior to loading the user profile page 170. The player profile picture 174 is similar to the user profile picture 148 in that it displays an illustration or photograph that represents the player. In a preferred embodiment, the player profile picture 174 contains a photograph of the player. The player location field 176 displays information associated with the player's geographic location. In a preferred embodiment, the player location field 176 includes the player's residence, their general area, or any area of interest to the player (i.e., where the player intends to participate in recreational activities). The player information field 178 displays the players name, contact information, or other relevant identifying information of the player. While each text input fields are intended to receive input relative to their label, the application of the present invention does not limit text input to any particular content.

In one embodiment, the application of the present invention includes a feature native to social media platforms that allows users to “follow” one another. The act of following an individual or being followed by other individuals indicates an interest in that person, player, or user. By following a player, the platform is operable to make information related to the followed player readily available to the user. In one embodiment, the followed player's posted content is made readily available by being automatically displayed on the user's social feed (i.e., a list of postings or other activities on the platform). In the discussion to follow, the word “following” in the context of following a user, following a player, or being followed by a user or player is intended to adopt the general meaning of the word as it pertains to the social media field.

The follow player button 180 is representative of a feature that allows a user to follow or subscribe to another player, such that, all of the player's posts, games, comments, and other activity on the platform is readily displayed to the user. The follow player button 180 is operable, upon selection, to cause the GUI of the mobile device to display a message, notification, or symbol to indicate that the player has been followed by the user. The followers field 182 represents how many individuals (i.e., other users of the platform) have selected the follow player button 180 for this specific player. The followers field 182 represents the number of players that are interested in this specific player and desire to be updated on this player's activities on the platform. The post field 184 represents the number of posts the player has created on the application of the present invention. The post field 184 represents the amount of content the player has contributed to the platform and is an indication of how active the player is on the platform. The following field 186 represents the number of players that the specific player (i.e., the player of the profile currently being viewed) has followed. The number in the following field 186 is representative of the number of players that the specific player is interested in.

The GUI of FIG. 4 includes a player biography field 188, which preferably includes information about the player in relation to the recreational activities and sporting event preference. The player biography field 188 is representative of the information that a player would like other users to know about themselves. The GUI of FIG. 4 also includes a player social feed 190, which displays all of the social posts and platform interactions that the player has broadcasted on the platform. Similar to the GUI of FIG. 3, the GUI of FIG. 4 includes navigation tab buttons 160.

In one embodiment, the application of the present invention is operable to allow users to converse through a private chat feature. In one embodiment, the private chat feature allows users to send message to one another in a private GUI that is accessible only to the individuals communicating with each other. In one embodiment, the application requires a player to select to accept a notification prior to engaging in a private chat with another user. In one embodiment, the private chat feature causes the GUI to display the messages in chronological order in the form of a list, such that each user is able to view the history of their conversation. In one embodiment, the application of the present invention is operable to allow users to converse through a video chat feature. In this embodiment, the application of the present invention is operable to communicate and function with a mobile device's camera, video, speaker, and microphone functionality. In this embodiment, a user has the option to select a call player button that is operable to cause the GUI of the mobile device to activate the front or back facing camera of the user's mobile device while requesting the front or back facing camera of another player's mobile device to be activated as well. In this embodiment, the player is presented, through a GUI of their mobile device, with the option to accept or decline the video call. In this embodiment, upon accepting a user's video call the player and the user will be connected such that they are able to see and hear each other through their mobile devices. In one embodiment, the application of the present invention is operable to allow users to converse through an audio chat feature. In this embodiment, the application is operable to communicate and function with a mobile device's microphone and speaker functionality.

In one embodiment, the application of the present invention is operable to allow users to mute or block other users. Inevitably, when large communities converse and interact on a single platform, some disagreements are likely to occur. In such a case, the application of the present invention is operable to allow users to prevent other users from communicating with them and vice versa. In this embodiment, the GUI of FIG. 4 has a mute and/or a block button. The mute button is operable to prevent any communication (i.e., messages, posts, calls, likes, comments, etc.) from reaching the user. The block button is operable to prevent any communication from reaching the user and disallows the user from viewing the player's profile and any evidence of their interaction with the platform. The mute and block button are operable to maintain harmony within the platform's community by allowing users to exclude communication from certain other users. In one embodiment, the block button is operable to exclude the block player from entering any of the user's hosted games. In one embodiment, the block button is operable to exclude the user from viewing any hosted games that the blocked player is participating in. In one embodiment, the mute button functions the same as the block button.

In one embodiment, the GUI of FIG. 4 includes a report button. The report button is operable to send a notification, private message, pop-up, email, or text message to an administrator of the platform to signify that the player has done some kind of misconduct on the platform. In one embodiment, the application is operable to cause the GUI of a user device to display a pop-up or drop-down menu with a number of options and text fields for the user to input information pertinent to the reason they reported the player. The report button is operable to inform administrators of the platform of a player who has either posted, or engaged in misconduct. In one embodiment, the report button is operable to mute and block the player.

In one embodiment, the application of the present invention is operable to display a player's statistics associated with their performance in a recreational activity or sporting event facilitated through the application onto the GUI of their user page 140 or player profile page 170. In one embodiment, the GUI of FIG. 4 displays statistics of the players performance in a recreational activity on the player's profile page 170. In one embodiment, the GUI of FIG. 3 displays statistics of the user's performance in a recreational activity or sporting event on the user's profile page 140. In this embodiment, the GUI displays completion percentage, passing yards, touchdowns, interceptions thrown, interceptions caught, passing rating, rushing yards, first downs, fumbles, possession percentage, assists, penalty shot completions, rebounds, blocks, steals, turnovers, elo rating, fantasy points, and/or any other sport or recreational activity statistics associated with player performance onto the user's profile page 140. In one embodiment, the game statistics are representative of those earned by a player over their entire career of using the application. In one embodiment, the game statistics are representative of those earned in a single game. In one embodiment, the game statistics are reported and uploaded via a user device corresponding to the user profile. In one embodiment, the game statistics are reported and uploaded by an independent reviewing organization who reports on the game statistics earned in recreational activities or sporting events.

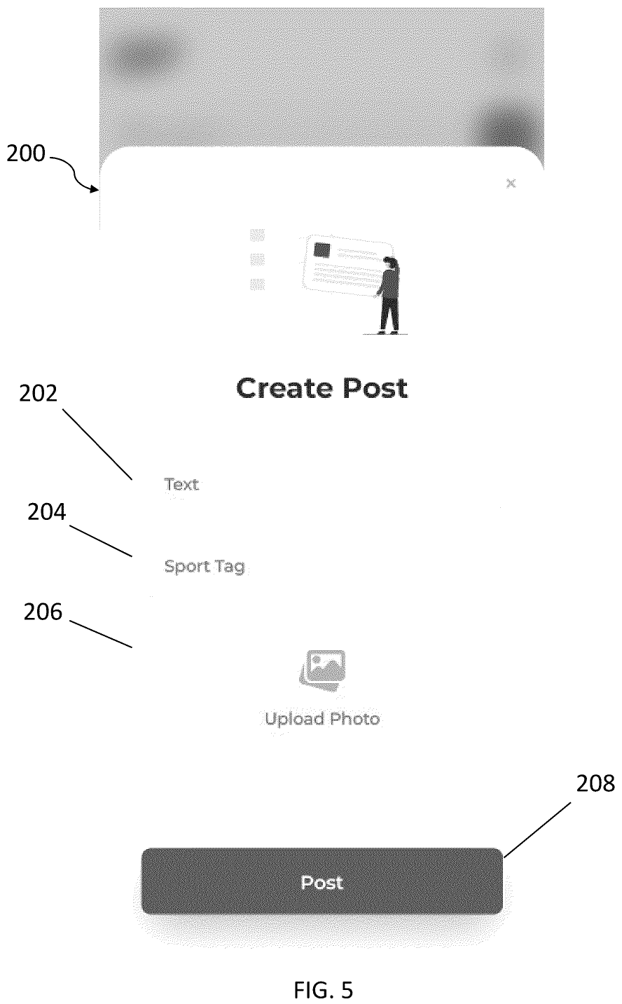

FIG. 5 illustrates a GUI for a social post creation menu 200 according to one embodiment of the present invention. The GUI of FIG. 5 is representative of the menu displayed on a user device to create a social post to be broadcasted on the platform and the text fields available to input information. In one embodiment, the application of the present invention allows users and players to create social posts to share content with others on the platform. In one embodiment, the post contains only simple text, an image, a video, a link, and/or other content. In the preferred embodiment, the server platform receives a request from a user device to create a post indicating that a user is hosting a recreational activity or sport for others to sign-up for (i.e., indicating that they wish to participate in the recreational activity or sport). In the preferred embodiment, the post shares content associated with a recreational activity or sporting event (e.g., a photograph of the user playing a sport). Specifically, the GUI of FIG. 5 includes a text field 202, a sport tag field 204, an upload media field 206, and a post button 208. The GUI of FIG. 5 allows a user device to input information into the text field 202, the sport tag field 204, and the upload media field 206, which is displayed on the social post once posted. A sport tag is representative of the category of sporting activity or recreational activity that the post is subject to. As an example, a user inputs “football” into the sport tag field 204 to indicate that the social post is related to the sport of football. In one embodiment, the GUI of FIG. 5 is operable to present a drop-down box from the sports tag field 204 with a list of predetermine sports tags, which allows a user to select which sport tag they wish to use rather than manually inputting it. The GUI of FIG. 5 allows the user to upload a photograph, video, or other media to the upload media field 206 to accompany their post, such that when the post is posted the photograph or media is visible. In one embodiment, the GUI of FIG. 5 is operable to access the stored photographs on the device running the application, access the camera on the device running the application, and/or access the internet in order to upload photos, videos. The post button 208 is operable to cause the GUI of the mobile device to share the text field 202, sport tag field 204, and the upload media field 206 (collectively referred to as “content”) to the social feed 230 of the platform.

In one embodiment, the application of the present invention is operable to allow players to like, dislike, comment, and/or share posts created by other users on the platform. In one embodiment, the GUI of the present invention is operable to display the likes, dislikes, comments, and/or shares of a given post directly on the post itself for other users to view.

In one embodiment, the application of the present invention is operable to allow a user to post a photograph, status, video, Graphics Interchange Format (GIF), poll, and/or discussion thread. It should be understood that the GUI of FIG. 5 represents the applications capacity to share a wide variety of content with others. The GUI of FIG. 5 is operable to post and share content in any way known in the art, such as through another social media website (i.e., TWITTER, INSTAGRAM, FACEBOOK, etc.). In one embodiment, content posted (via the post button 208) appears on the social feed page 230 (discussed later) of the application for other players to see and interact with.

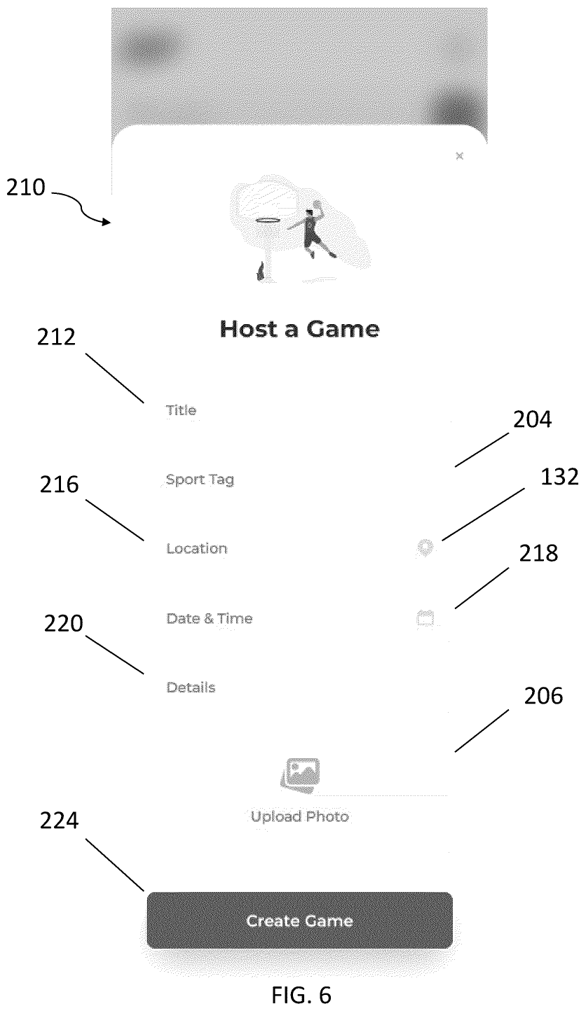

FIG. 6 illustrates a GUI for a host-a-game creation menu 210 according to one embodiment of the present invention. The GUI of FIG. 6 is representative of the menu displayed of the GUI of a user device to a user when they would like to host a recreational activity or sport activity on the platform. The host-a-game feature is a key component to the present invention and is implemented through a GUI, such as that shown in FIG. 6. The host-a-game feature allows users to create a social post or a “host a game post” to signify their undertaking to host a recreational activity, sports game, contest, tournament, or other event. The host a game post informs players of the platform that a user intends to invite others to play the recreational activity with them. The host-a-game post is operable to allow users to sing up for the posted recreational activity, sports event, tournament, contest, or other event.

Specifically, the GUI of FIG. 6 includes a host-a-game creation menu 210, a title field 212, a sport tag field 204, a game location field 216, an auto-fill location button 132, a date and time field 218, a details field 220, an upload media field 206, and a create a game button 224. The host-a-game post incorporates the information input into the title field 212, the sport tag field 204, the game location field 216, the date and time field 218, the details field 220, and the upload media field 206. The title field 212 is operable to allow a user to input a title to associate with the host a game post. The sport tag field 204 is operable to allow a user device to input a sport tag, which signifies the sport or recreational activity that the user intends to play (e.g., football, soccer, tennis, basketball, etc.), to associate with the host a game post. The game location field 216 is operable to allow a user device to input a geographic location (e.g., an address, sports field, general area, etc.) to associate with the host a game post. The game location field 216 informs players of where the recreational activity or sporting event is intended to be played. The auto-fill location button 132 is operable to cause the GUI of the mobile device to input the current location of the user into the user location field 126 based on geo-location data. In one embodiment, the auto-fill location button 132 is operable to communicate with a GPS or other geo-location sensitive device of a user device to determine the current location of the user. In one embodiment, the auto-fill location button 132 is operable to communicate with a web mapping platform (e.g., GOOGLE MAPS, APPLE MAPS, etc.) to allow a user to select a location for the game location field 216. The date and time field 218 is operable to allow a user to input a date and time associated with the host a game post. In a preferred embodiment, a user inputs the date and time of the recreational activity or sports game associated with the host a game post into the data and time field 218. The date and time field 218 informs players of when the recreational activity or sport is going to be played or planned to be played. The details field 220 is operable to allow a user to input any additional information they desire potential players to be aware of. In the preferred embodiment, information relevant to potential players of the hosted game is input into the details field 220. The GUI of FIG. 6 allows the user to upload a photograph, video, or other media to accompany their host-a-game post, such that, when the post is posted, the photograph, video, or media is visible. In one embodiment, the GUI of FIG. 6 is operable to access the stored photographs on the device running the application, access the camera on the device running the application, and/or access the internet in order to upload photos and videos. The create-a-game button 224 is operable to cause the GUI of the mobile device to share the information provided in the title field 212, the sport tag field 204, the game location field 216, the date and time field 218, the details field 220, and the upload media field 206 in the form of a social post to the social feed 230. In one embodiment, the create a game button 224 is operable to create and post a host-a-game post.

In one embodiment, a host-a-game post is operable to be edited by the poster (i.e., the user who created the host a game post) after the post has been created. In one embodiment, a host-a-game post is operable to be deleted by the poster after the post has been created. In one embodiment, a host-a-game post is operable to be hidden to specific players, such that the post is not visible to the targeted player. In one embodiment, a host-a-game post is operable to be automatically hidden to players who are blocked by the user posting the host game post.

In one embodiment, a host-a-game post is displayed on the GUI of the social feed page 230 of the players who follow the user profile that created the post. In one embodiment, a host-a-game post is displayed on the GUI of the social feed page 230 of all players on the platform. In one embodiment, a host-a-game post is displayed on the GUI of the social feed page 230 of players in the general geographic proximity of the user profile that created the post. In one embodiment a host-a-game post is displayed on the GUI of the social feed page 230 of players within a predetermined radius centered around the geographic location of the user or user device that created the post. In one embodiment a host-a-game post is displayed on the GUI of the social feed page 230 of players within a predetermined geofencing boundary. In one embodiment, a host-a-game post is displayed on the GUI of the social feed page 230 of some or all of the players on the platform. In one embodiment, a host-a-game post is displayed on the GUI of the social feed page 230 of players who are interested in or subscribed to the sport tag associated with the host a game post. In one embodiment, a host-a-game post is displayed on the GUI of the social feed page 230 of players according to social media recommendation algorithms known in the art (discussed below).

In one embodiment, the GUI of the host-a-game creation menu 210 includes prerequisite fields that allow the user making the post or “poster” to create a number of preconditions that a player must meet prior to signing up for the game. In one embodiment, the game creation menu 210 includes an age, experience, geographical proximity, sport tag, sport type, gender, height, or skill level prerequisite field. In one embodiment, the GUI of the present invention is operable to notify a player when they have signed up for a game that they do not meet one or more of the prerequisites.

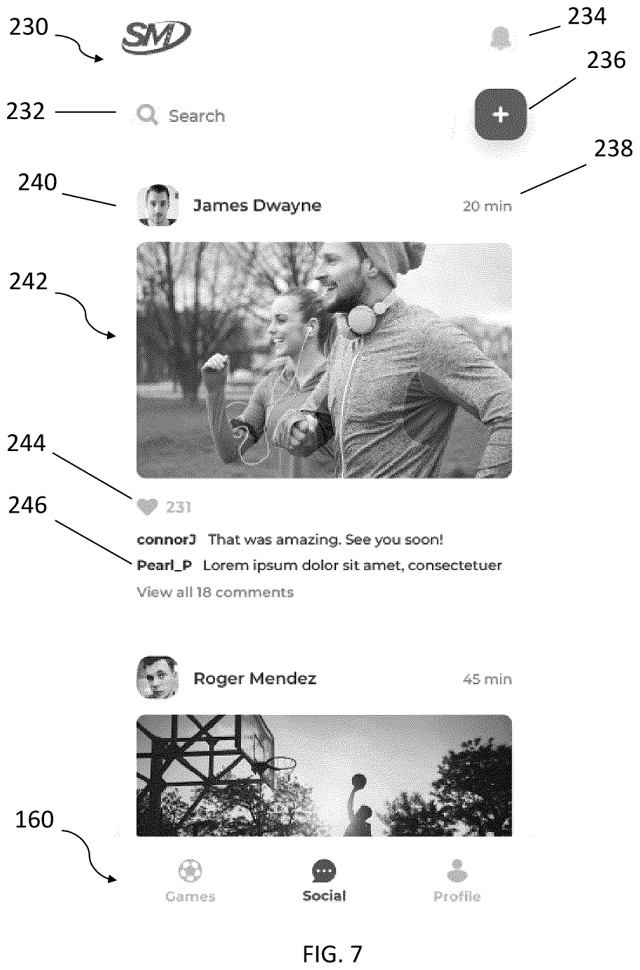

FIG. 7 illustrates a GUI for a social media feed 230 according to one embodiment of the present invention. FIG. 7 illustrates one example of a social media feed 230, but one of ordinary skill in the art will understand that other visualizations of a social media feed are also able to be used according to the present invention. However, the application of the present invention is operable to present a unique social media feed 230 to any user of the platform. In one embodiment, the social media feed 230 is an updated list of all the content posted on the platform. In one embodiment, the social media feed 230 displays content posted by a user's follows, friends, subscriptions, or by the sport tag used. In one embodiment, a user's social media feed 230 is configured to display content posted by players in a predefined geographical proximity to the user device, such that the user is made aware of the sporting activities occurring in their general location. In one embodiment, a user's social media feed 230 is configured to display content posted by players on the user's mobile phone contact list (i.e., by connecting phone numbers in the user's mobile phone to the application). In one embodiment, a user's social media feed 230 is configured to display content based on a recommendation algorithm designed to present content that the user is likely to be interested in. In one embodiment, the application of the present invention is operable to allow users to view public posts representative of the entire community's use of the application.

Specifically, the GUI of FIG. 7 includes a search bar 232, a notification button 234, a post creation menu button 236, a time-stamp 238, a user identifier field 240, a social post 242, a “like” indicator 244, player comment field 246, and navigation tab buttons 160 previously discussed. The search bar 232 is operable to allow a user to search for posted content by keyword, time, category, hashtag, player name, popularity, or other searchable factor known in the art. The notification button 234 is operable to cause the GUI of the mobile device to load a page corresponding to a notification settings menu. In one embodiment, the notification settings menu is operable to allow a user to toggle different notification settings known in the art. In one embodiment, the notification button 234 is operable to cause the GUI of the mobile device to display a drop-down menu with notification options (e.g., when a notification is able to appear, how often notifications are able to appear, what types of actions generate a notification, etc.). The post creation menu button 236 is operable to cause the GUI of the mobile device to load a page corresponding to the host a game creation menu 210 of FIG. 6. The social post 242 is a content post created via the social post creation menu 200 of FIG. 5. In one embodiment, the social post 242 is a content post created via the host a game creation menu 210 of FIG. 6. The social post 242 includes a time-stamp 238, a user identifier field 240, a like indicator 244, and a player comment field 246. The time stamp 238 indicates the length of time that has passed since the social post 242 was originally posted. The user identifier field 240 displays the profile picture and name of the user profile that originally posted the social post. The like indicator 244 displays the number of players that have “liked” the social post 242. The player comment field 246 displays comments left my players on the social post 242. In one embodiment, the like indicator 244 is operable to function as a GUI button, in that, upon click selection, the social post 242 is “liked” by the user. In one embodiment, the comment field 246 is operable to function as a GUI button, in that, upon selection, a text box is displayed on the user device that is operable to receive text input and be posted to the social post 242.

In one embodiment, the social post 242 includes a favorite button that is operable to cause the GUI of the mobile device to indicate that a specific post has been favorited. In this embodiment, the favorited posted is archived on the user's account, such that the user profile is able to easily access the post at a later time. In one embodiment, the social post 242 includes a dislike button that is operable to cause the GUI of the mobile device to indicate that the post is disliked by the user. In one embodiment, the dislike button is operable to subtract from a total number of likes on the like indicator 244. In one embodiment, the dislike button is operable to increase the number of a dislike indicator (i.e., that is an indicator similar to the like indicator 244 but tallies dislikes rather than likes). In one embodiment, the social post 242 includes a mute button that is operable to cause the GUI of the mobile device to indicate that the user profile who posted the social post 242 is muted. In one embodiment, the social post 242 includes a block button that is operable to block the user profile who posted the social post 242. In one embodiment, the block button is operable to hide the social post 242 from the user's social feed. In one embodiment, the block button is operable to hide any subsequent social posts 242 from the original poster from the user's social feed. In one embodiment, the social post 242 includes a repost button that is operable to post the social post to the user's social feed as if they had created the social post themselves. In this embodiment, the reposted social post 242 has an indicator in the form of a repost symbol to represent who the original poster is and who the re-poster is.

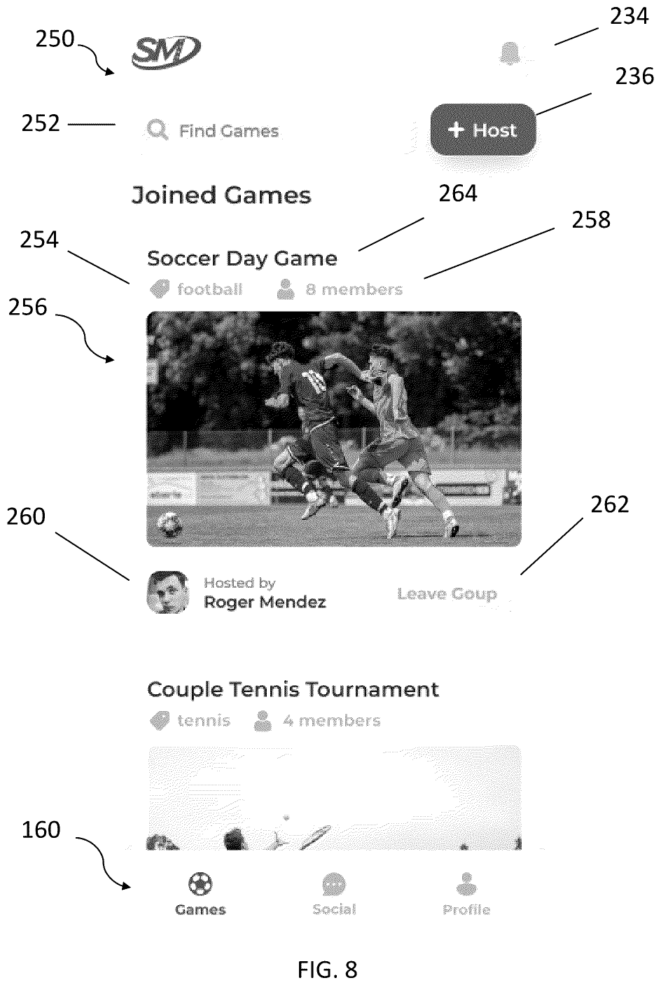

FIG. 8 illustrates a GUI for a joined game menu 250 according to one embodiment of the present invention.

FIG. 8 illustrates an example of what a specific user's joined game menu 250 looks like. However, the application of the present invention is operable to present a unique joined game menu 250 for each user profile depending on the games the user profile has signed up for. The joined game menu 250 is operable to display a list of the recreational activities or sporting events that the user profile has signed up for (i.e., plan to participate in). In one embodiment, the joined game menu is accessible from any page within the application by selecting the games tab button.

Specifically, the GUI of FIG. 8 includes a joined game menu 250, a find game search field 252, a notification button 232, a post creation menu button, a sport tag 254, a host a game post 256, a game title 264, a member count field 258, a host identification field 260, a leave group button 262, and the navigation tab buttons 160 previously discussed.

The find game search field 252 is operable to receive text input of a keyword, time, category, hashtag, player name, popularity, or other searchable factor known in the art in order to identify a specific joined game. In one embodiment, the notification button 234 is operable to cause the GUI of the mobile device to load a page corresponding to a notification settings menu. In one embodiment, the notification settings menu is operable to allow a user to toggle different notification settings known in the art. The post creation menu button 236 is operable to cause the GUI of the mobile device to load a page corresponding to the host a game creation menu 210 of FIG. 6.

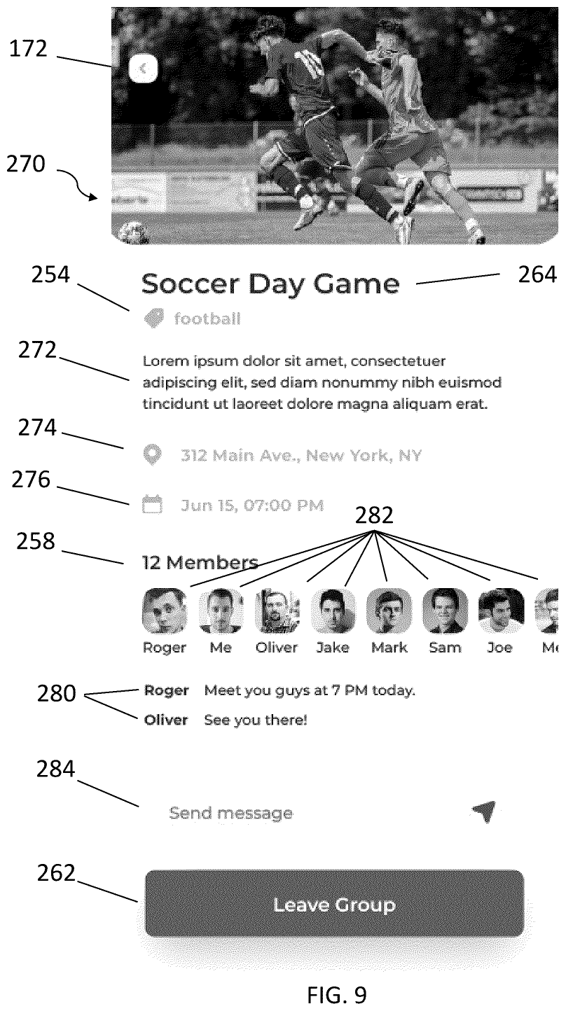

The host-a-game post 256 is representative of a player's desire to host a recreational activity or sport game. The host-a-game post 256 is the mechanism to which a user creates a post to indicate their intention to host a recreational activity or sporting event and the mechanism to which a player is able to sign up for the recreational activity or sporting event to signify their intention to participate in the hosted event. The host-a-game post 256 includes a sport tag field 254, a game title 264, a member count field 258, a host identification field 260, and a leave group button 262. The sport tag field 254 represents the category of recreational activity associated with the host-a-game post 256. In one embodiment, the GUI of the host-a-game post 256 includes a join group button in place of the leave group button 262. In this embodiment, the join group button is operable (e.g., upon click selection) to add the player to the member count field 258, add the player's profile picture and name to the plurality of player profile pictures 282, and cause the GUI to load a page corresponding to the detailed game menu 270 of FIG. 9. In this embodiment, the application is operable to allow players to join recreational activities and sporting events by selecting the join group button, which is representative of their intent to participate in the event. In one embodiment, the application is operable to send a notification to the GUI of the user device of the creator of the host a game post 256 in the form of a pop-up notification, push-notification, text message, email, or similar notifying method. The game title 264 represents the name associated with the sporting event or as an identifier of the specific event to take place. The member count field 258 represents the number of players that have signed up for the sporting event (i.e., intended to participate in the recreational activity). The host identification field 260 includes the profile picture and name of the player who intends to host the recreational activity and created the host a game post. The leave group button 262 is operable to cause the GUI to remove the user profile from the list of members (i.e., intended participates) from the host a game post 256 to signify that the user will no longer partake in the recreational activity.

In one embodiment, the game title 264 functions as a GUI button. In this embodiment, the game title 264 is operable to be selected by a user which causes the GUI to load a page corresponding to the detailed game menu 270 of FIG. 9.

In one embodiment, the creator of a host a game post 256 requires players to request to join a recreational activity or sporting event rather than being automatically added to the list of members 258. In this embodiment, the player requesting to join the recreational activity or sporting event is not added to the member count field 258 until the request is approved by an administrator use profile associated with the event. In one embodiment, once a player has requested to join an event, the creator of the host-a-game post 256 and/or another administrator account associated with the host-a-game post 256 receives a message, text box pop-up, or push notification through the GUI of their user device, which presents the user with the option to accept or deny the player's request. In one embodiment, the creator of the host-a-game post 258 receives a notification of the request to join the event in the form of a push-notification, pop-up notification, text message, email, or other similar notifying method.

FIG. 9 illustrates a GUI for a detailed game menu 270 according to one embodiment of the present invention. FIG. 9 illustrates a GUI for a detailed view of a host-a-game post 256, such that a player is able to view the specific details associated with a recreational activity or sporting event on a user device. The detailed game menu 270 of FIG. 9 present all the necessary information needed to participate in the recreational activity or sporting event to its intended participants (i.e., the players who have signed up for the game). The detailed game menu 270 allows the original creator to manage the specific details associated with the recreational activity or sporting event. Specifically, the GUI of FIG. 9 includes a detailed game menu 270, a return button 172, a sport tag 254, a game title 264, a host game description 272, a game location description 274, a date and time field 276, a member count field 258, a plurality of player profile pictures 282, a comment section 280, a message text box 284, and a leave group button 262.

The return button 172 is operable to cause the GUI of the mobile device to load the interface page that was loaded prior to loading the user detailed game menu 270. The sport tag field 254 represents the category of recreational activity or sporting event associated with the host-a-game post 256. The game title 264 represents the name associated with the sporting event or as an identifier of the specific event to take place. The host game description 272 includes information pertaining to the recreational activity or sporting event intended to take place. In one embodiment, the host game description 272 is operable to receive text input and display it to other players. In one embodiment, the host game description 272 is subject to a character limit (i.e., the GUI of the user devices restricts the text input of the user to a specific maximum number of text characters). The game location description 274 represents geographic location information related to the recreational activity or sporting event intended to take place. In the preferred embodiment, the address of the location where the players intend to participate in the reactional activity or sporting event is included in the game location description 274. The date and time field 276 is representative of the date and time that the recreational activity or sporting event is intended to take place. The member count field 258 displays the number of players that have signed up for the sporting event. The plurality of player profile pictures 282 corresponds to the member count field 258 and displays the player profile picture and name of the individuals who have signed up to participate in the recreational activity or sporting event. The message text box 284 is operable to permit players to submit comments in the form of text to other participants of the hosted game. The comment section 280 displays a chronological list of the comments submitted to the text box 284 by the participants of the hosted game. The comment section 280 and text box 284 allow players who have signed up for the hosted game to interact with each other. The leave group button 262 is operable remove the user profile from the list of participants for the hosted game. The leave group button 262 allows players to exclude themselves from hosted games that they have signed up for but no longer intend to participate in.

In one embodiment the detailed game menu 270 includes an edit button that is operable to cause the GUI of the user device to allow the user to edit the details of the host-a-game post 256, add or remove players, edit comments, edit the title field 264, edit the sport tag 254, edit the host game description 272, edit the date and time field 276, edit the game location description 274, or edit other parameters of the host-a-game post 256. In one embodiment, the edit button is accessible only by the original creator of the host-a-game post 256. In one embodiment, the GUI of the detailed game menu 270 is operable to allow the original creator of the host a game post 256 to grant permissions to other players who have signed up for the game. In this embodiment, the permissions allow a player to edit the details of the host-a-game post 256, add or remove players, edit comments, edit the title field 264, edit the sport tag 254, edit the host game description 272, edit the date and time field 276, edit the game location description 274, or edit other parameters of the host-a-game post 256.

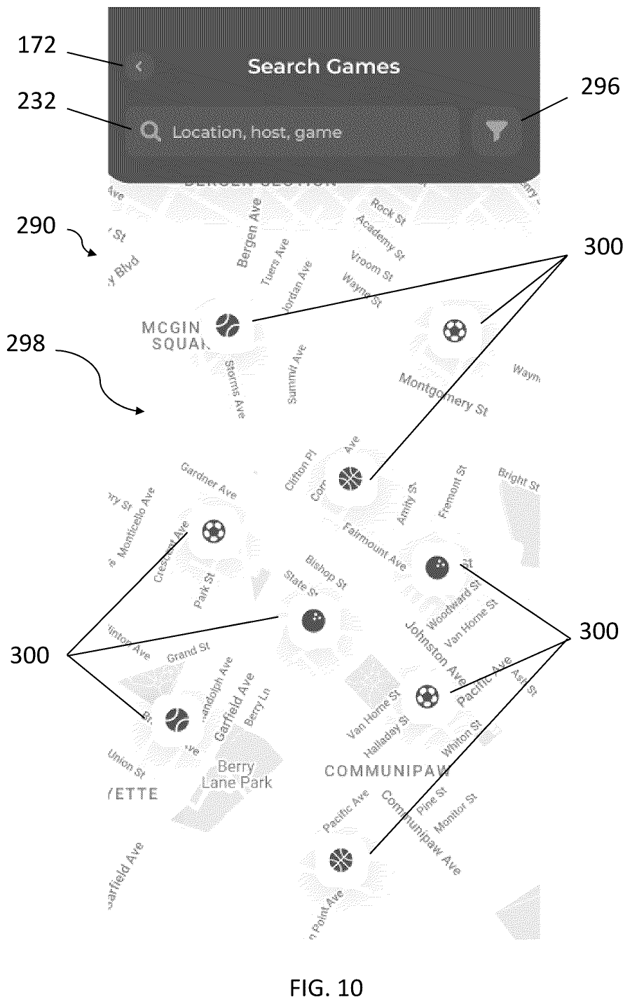

FIG. 10 illustrates a GUI for a proximity-defined game map interface 290 according to one embodiment of the present invention. In one embodiment, the application of the present invention is operable to communicate with the user device running the application to access geo-location data. In one embodiment, the application of the present invention is operable to communicate with a Global Positioning System (GPS) of the user device. In one embodiment, the application of the present invention is operable to communicate with a user device to determine location data through the IP address of the user device, the IP address of the WIFI router or modem connected to the user device, or other similar geo-location determination method known in the art. In this embodiment, the application of the present invention is operable to associate geo-location data with a host-a-game post 256, such that the location where the host-a-game post 256 was created or the location input into the host-a-game post (i.e., in the game location description 274 or in the game location field 216) is overlayed onto a map (as seen in FIG. 10). In this embodiment, the application of the present invention is operable to compile the locations of a multitude of host-a-game posts 256 and overlay the compiled locations onto a map interface.

In one embodiment, as shown in FIG. 10, the GUI includes a proximity-defined game map interface 290, a return button 172, a search bar 232, a filter button 296, a map overlay 298, and/or hosted game icons 300. The proximity-defined game map interface 290 allows users to visualize the recreational activities and sporting events available for sign-up in their general area. In one embodiment, the proximity-defined game map interface 290 is operable to receive selection input in the form of a dragging motion, such that a user device is able to manipulate and navigate the map overlay and view hosted games in surrounding areas. The return button 172 is operable to cause the GUI of the mobile device to return the user device to the page they were previously viewing prior to accessing the proximity-defined game map interface 290. The search bar 232 is operable to allow a user device to search for posted games by keyword, time, category, hashtag, player name, popularity, or other searchable factor known in the art. The filter button 296, upon selection, is operable to cause the GUI of the user device to load a page corresponding to a filter menu. In one embodiment, the filter menu displays a number of filter options including sport tag, proximity, title, host, participants, location, and other recreational activity parameters. In one embodiment, the filter button 296 is operable to cause the GUI of the user device to display a drop-down box to display the filter options for selection. In one embodiment, the filter options are operable to cause the GUI of the user device to display or hide hosted game icons 300 or specific types of game icons 300 depending on the filter options selected. The map overlay 298 represents the overlay onto which the hosted game icons 300 are placed to give a user a visual representation of where the hosted games are intended to be played at. In one embodiment the map overlay 298 includes satellite imagery, aerial photography, or street maps. The hosted game icons 300 correlate to the locations associated with host a game posts 256, such that the location information input into the location field 216 is geo-spatially displayed on the map overlay 298.

In one embodiment, the application is operable to cause the GUI of the user device to load a page corresponding to the detailed game menu 270 upon selection of a hosted game icon 300. In one embodiment, the application is operable to add a user to the member count field 258 of a host a game post 256 upon selection of a hosted game icon 300.

In one embodiment, the proximity-defined game map interface 290 visualizes recreational activities or sporting events centered around the user's current location. In one embodiment, the proximity-defined game map interface 290 visualizes recreational activities or sporting events centered around a predetermined location or a selected area. In one embodiment, the proximity-defined game map interface 290 visualizes recreational activities or sporting events centered around a popular area or the area most frequented by the user profile when using the application of the present invention. In one embodiment, the map overlay 298 is operable to cause the GUI of the user device to display fields, courts, pitches, stadiums, rinks, arenas, or other locations where recreational activities and sporting event are frequented.

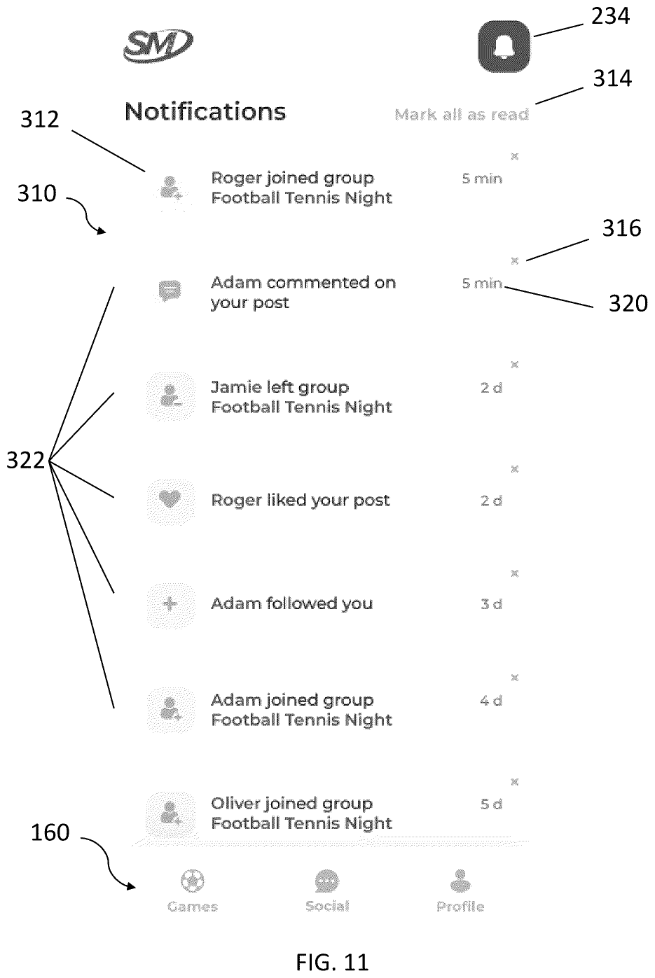

FIG. 11 illustrates a GUI for a notification menu 310 according to one embodiment of the present invention. In one embodiment, the application of the present invention is operable to cause the GUI of the user device running the application to send a notification, pop-up, text message, email, or other type of announcement to signify activity on the platform. FIG. 11 illustrates a plurality of notifications 322 sent to the user device in the form of a list, such that the user is updated on the activities occurring on the platform. In one embodiment, the plurality of notifications 322 include notifications only for activities that reference the user.

Specifically, the GUI of FIG. 11 includes a notification menu 310, a notification symbol 312, a notification button 234, a mark all as read button 314, a delete button 316, a notification time-stamp 320, a plurality of notifications 322 in the form of a list and three navigation tab buttons previously discussed. The notification icon 312 signifies the type of notification (i.e., like, dislike, comment, sign up, follow, etc.) associated with the notification 322. The notification button 234 is operable to cause the GUI of the mobile device to load a page corresponding to a notification settings menu. In one embodiment, the notification settings menu is operable to allow a user to toggle different notification settings known in the art. The mark all as read button 314 is operable to cause the GUI of the user device to change the shading of the plurality of notifications 322 to a dimmer hue, such that a user will recognize that the notifications 322 have been acknowledged or viewed. In one embodiment, the notifications 322 are operable, upon selection, to cause the GUI of the user device to dim the notification 322 that was selected. The delete button 316 is operable to cause the GUI of the user device to delete the notification 322 from view, such that it is no longer displayed on the notification menu 310. The notification time stamp 320 is operable to display the length of time that has passed since the activity represented by the notification occurred. In one embodiment, the notification icon 312 is operable as a button. In this embodiment, upon selection of a notification icon 312, the application is operable to cause the GUI of the user device to load a page corresponding to the selected post, like, user, host a game post, or other activity associated with the notification 322.

In one embodiment, the notification menu 310 is operable to inform the user about upcoming events, messages received, likes, dislikes, comments, followers, game statistics, games joined, players joined, or points scored in games to the user. In one embodiment, the notification menu 310 is operable to inform the user on events occurring in the geographical proximity of the user or user device on the application.

In one embodiment, similar to the notification menu 310, the application of the present invention is operable to cause the user device running the application to display a leaderboard. In this embodiment, the leaderboard signifies a ranking of players and displays statistics associated with the player's performance in recreational activities or sporting events managed through the application. In one embodiment, the statistics associated with a player's performance is recorded by the individual player themselves. In one embodiment, the statistics associated with the player's performance are recorded by an independent statistic reporting body. In one embodiment, the statistics associated with the player's performance is recorded by spectators to the recreational activity or sporting event. In one embodiment, the application of the present invention is operable to share statistics and leaderboards to other social media platforms (FACEBOOK, TWITTER, INSTAGRAM, REDDIT, DISCORD, etc.). In one embodiment, the application of the present invention is operable to share statistics and leaderboards via generation of a URL link that is operable to receive click selection and load a page corresponding to the leaderboard page of the platform. In one embodiment, click selection of the leaderboard URL link is operable to load a page native to the application that displays the leaderboard. In one embodiment, click selection of the leaderboard URL link is operable to load a webpage that displays the leaderboard.

In one embodiment, the user profile is subject to a number of toggleable privacy settings, such as: limiting player's ability to view a user's profile; limiting users' ability to message an account; content filters; limiting the platform's data collection; limiting the platform's collection of geo-location data; and other privacy settings known in the art.

In one embodiment, the user profile is subject to a number of toggleable content settings, such as: excluding profane content; excluding religious affiliated content; excluding political affiliation content; excluding explicit content; blocking users; muting users; and other content moderating settings known in the art.

In one embodiment, the user profile is associated with a parental account. In this embodiment, the parental account is able to control visibility of content or limit the functionality of the user profile, such as the parental account changing the privacy or content settings of the user profile. In one embodiment, the parental account is operable to limit the amount of time the user profile is allowed access to the application of the present invention within a preset time period (e.g., every day, every week, etc.). In one embodiment the parental account has access to historic data associated with the user profile, such that the parental account views the user profile's activity or history of activity on the application of the present invention.

In one embodiment, the application of the present invention is operable to suggest players with which to participate in recreational activities and sporting events. In one embodiment, the application is operable to suggest recreational activities or sporting events to the user profile. In this embodiment, the application of the present invention is operable to receive data associated with the user's sporting preference, player preference, location preference, date and time preference, and other factors related to a user's sporting tendencies. In one embodiment, the application of the present invention is operable to receive associated data and use the information in a recommendation algorithm. In one embodiment, the recommendation algorithm is based off a collaborative filtering (CF) that utilizes the user's past interactions between users and items. In one embodiment, the recommendation algorithm incorporates data regarding a user's content, posts, friends, and cookies on the platform or with respect to at least one associated social media profile. In one embodiment, the recommendation algorithm suggests players to play with, posts to interact with, sporting events to participate in, sporting events to spectate, coaches to train with, and locations for hosting sporting events (“suggested content”). In one embodiment, the suggested content is included on the social feed 230. In this embodiment, the recommendation algorithm is operable to make suggestions to aid the user in their sports matchmaking experience.

In one embodiment, the application of the present invention is operable to create visualizations of statistics earned through recreational activities and sporting events managed through the platform. In this embodiment, the application is operable to create bar graphs, pie graphs, line graphs, area graphs, scatter plots, and other statistic visualization aids. In one embodiment, the application is operable to create a list of the recreational activities and sporting events participated in by the user, such that the user profile displays a chronological list of games played through the platform.

In one embodiment, the application of the present invention is operable to link to a number of financial accounts, such as bank accounts, crypto wallets, checking accounts, or credit accounts. In one embodiment, the application is operable to charge payments to a user's financial account. In one embodiment, the application is operable to deposit payments to a user's financial account. In one embodiment, the application is operable request payment from users. In one embodiment, the application is operable to allow users to request payments from other users.

In one embodiment, the application is operable to receive a plurality of wagers from a user device. In this embodiment, the application of the present invention is operable to receive a wager from a user, whereby the wager is dependent on a plurality of variables associated with a recreational activity or sporting event. In this embodiment, the application is operable to either charge the user's financial account or deposit funds into the user's financial account based on the variables associated with the recreational (i.e., if the chosen team wins the sporting event the user receives funds but if the chosen team loses the sporting event the user is charged funds). In one embodiment, the application includes a smart contract associated with a user profile's wager, such that upon the happening of the event subject to the wager (i.e., the team predicted to win, wins) funds are automatically transferred to the financial account associated with the user profile. In one embodiment, funds are manually transferred upon the happening of the event subject to a user profile's wager.

In one embodiment, the application is operable to accept wagers or bets, deposit funds, and request funds through smart contracts. In one embodiment, a smart contract is one or more are computer protocols enabled by a blockchain that facilitate, verify, or enforce a negotiation or performance of self executing code, or that make a contractual clause unnecessary. As a non-limiting example smart contracts emulate the logic of contractual clauses. In one embodiment smart contracts are partially or fully self-executing, self-enforcing, or both. In one embodiment a blockchain itself is programmed to trigger transactions automatically. As a non-limiting example, a smart contract is able to self-execute, and the smart contract handles the enforcement, the management, performance and payment. As a non-limiting example, smart contracts manage transactions based upon outcomes. As a non-limiting example, a smart contract is a self-operating computer program that automatically executes when specific conditions are met. As a non-limiting example, because smart contracts run on the blockchain, they execute as programmed without censorship, downtime, fraud or third-party interference.

In one embodiment, the application of the present invention is operable to host a coaching session. In this embodiment, rather than creating a post to seek participants for a recreational activity or sporting event, the application is operable to create a post to seek participants for a coaching session. In this embodiment, either a coach profile creates a post seeking a player to train or a player profile creates a post seeking a coach. In one embodiment, the user profile creating the post associates a monetary value with the service they seek to render or receive. In this embodiment, the application is operable to automatically charge or deposit funds to the user's account based on the monetary value associated with the service (i.e., a coach requires a player to send money to the coach's account in order to sign up for the coaching session or a player allows a coach to receive money for signing up for the coaching session).

In one embodiment, the application is operable to provide a real-time confirmation that a purchase, charge, or deposit has been completed. In one embodiment, the application is operable to send a notification to the user device in the form of a pop-up, text message, phone call, email, or other notifying mechanism.

In one embodiment, the GUI displays a recommendation to the user. In one embodiment, the recommendation is a player to participate with, a sporting event to sign up for, a venue to play a recreational activity at, a data and time to play or host a sporting event, a coach to train with, a player to follow, or a post to interact with. In one embodiment, a notification is generated on the GUI that represents a recommendation. In one embodiment, the recommendation to the user is derived from association data. In one embodiment, the association data is derived from the user's geographical location, the user's recreational activity or sporting event preference, the user's follow or friends list, the user's history of frequented data and time for using the application, the user's gender, the user's age, the user's preferred sporting position, the user's preferred sport, the user's history of frequented venues, and/or the user's cookies derived from internet use. In one embodiment, the application is operable to run a recommendation algorithm to process association data to make a recommendation. In one embodiment, the application utilizes collaborative filtering (CF) to recommend content to a user profile. In one embodiment, the application utilizes matrix decomposition to recommend content to a user profile. In one embodiment, the application utilizes collaborative filtering, matrix decomposition and/or other recommendation algorithms known in the art to recommend content to a user profile. In one embodiment, the application is operable to cause the GUI of the user device to display a recommendation to the user and is operable to give the user the ability to accept or deny the recommendation. In one embodiment, the application is operable to cause the GUI of the user device to display a list of recommendation to the user to select from. In one embodiment, the application is operable to refine the recommendation algorithm based off of a history of selections of previous recommendations by the user. In one embodiment, the application is operable to exclude recommending content or players associated with blocked or muted players.

In one embodiment, the GUI is operable to display a social media feed (as illustrated in FIG. 7). In one embodiment, the social media feed includes user posts, host-a-game posts, likes, dislikes, follows, comments, coaching posts, wagers, game statistics, and other content associated with the platform. In one embodiment, the social media feed is formed by a scrolling list of content on the GUI of a user device running the application. In one embodiment, the application is operable to cause the GUI of the user device to load a page corresponding to a detailed view of a specific content post upon selection. In one embodiment, the application is operable to cause the GUI of the user device to exclusively display content associated with hosting a recreational game or sporting event and signing up for a recreational games or sporting events. In one embodiment, the GUI displays content based on the user's proximity to the content's creator's (i.e., content created and posted within the user's general geographical location).

In one embodiment, the application allows users to sign up for recreational games and sporting events via a join group button on the GUI. In this embodiment, the join group button is operable, upon click selection, to add the user profile to a list of players who intend to participate in the recreational activity or sporting event. In one embodiment, the list of participants (i.e., have selected the join group button) is displayed exclusively to the host. In one embodiment, the list of player participants is displayed to all players who have signed up for the same recreational activity or sporting event. In one embodiment, the GUI displays a leave group button (as seen in FIG. 9) after a user has selected the join group button. In one embodiment, the GUI is operable to remove the user profile from the list of participants upon selection of the leave group button.

In one embodiment, the GUI displays a visual representation of a map with recreational games and sporting event icons overlayed on top of the map (as seen in FIG. 10). In one embodiment, the sporting event icons represent recreational activities or sporting events managed by the application. In one embodiment, the sporting event icons are created by a host-a-game post. In one embodiment, the GUI is operable to display sporting event icons onto a map overlay that represent hosted games in a relatively close geographic proximity to the user device. In one embodiment, the map interface is operable to, upon selection, zoom in or out to display a small section or a larger section of the map overlay. In one embodiment, the GUI is operable to display a map overlay of a location not defined by the user's proximity. In this embodiment, the application is operable to receive a location input from a user device and display a map icon representative of the input location.

In one embodiment, the GUI for the application includes a user profile page. In one embodiment, the user profile page includes information associated with the user, information associated with the user's recreational activity history, information associated with user's preferences, information associated with a user's biological features, and/or any other information the user wishes to display to others on the platform. In one embodiment, the user profile is operable to receive input associated with the user's performance (i.e., statistics) in recreational activities and sporting events managed through the platform. In one embodiment, the user inputs statistics into their user profile. In one embodiment, an independent reporting body inputs statistics into a user profile. In one embodiment, the user statistics include points scored, assists earned, passes completed, rebounds received, games played, time on the field, positions played, tackles, sacks, interceptions, yards gained, yards lost, and other mathematical representations of player performance.

In one embodiment, the GUI displays a safety level of a location (i.e., a field, court, stadium, arena, etc.). In one embodiment, the safety level is determined by compiling user perceived safety ratings for each location (i.e., how safe they perceive the location to be). In one embodiment, the GUI is operable to receive safety opinion input. In this embodiment, the GUI of the user device is operable to receive a rating and compile it with other user ratings for the same location. In effect, the application is operable to rank the relative safety of a location by taking the average safety rankings of all those safety rankings submitted by users and display it on the platform for users to view.

The safety feature allows users to make an informed decision on when and where they desire to participate in sporting events, such that they have a safe and fun sporting experience. In one embodiment, the safety feature is dynamic and changes overtime based on user input received. In one embodiment, the application is operable to cause the GUI to display a feedback field. In this embodiment, a user inputs a comment or general description of the location as it relates to its perceived safety levels. In one embodiment, the application is operable to flag specific locations based on their safety level. As an example, the application is operable to flag a location as unsafe after it has received user input that results in a safety level below a predetermined value. As another example, the application is operable to flag a location as safe after the application has received user input that results in a safety level above a predetermined value. In one embodiment, the GUI displays the number of user profile inputs received for a specific location, the amount of unsafe and safe user inputs received for a specific location, and any comments or feedback left about a specific location. In one embodiment, the application is operable to cause the GUI of the user device to display five empty stars for the user to select. In this embodiment, a user will select the number of stars they believe represent the relative safety of the location of interest (i.e., the user will select five starts if they believe the location to be extremely safe and one start if they believe the location to be extremely unsafe). In one embodiment, the relative safety level of a location is represented by a series of stars, such that the greater number of stars associated with a location the greater the safety level. In one embodiment, locations are rated on a scale of one to five, whereby one star indicates an unsafe location and 5 stars indicate a safe location.

In one embodiment, the GUI displays the relative safety level onto the proximity-defined game map interface 290, such that a user is able to determine the relative safety of a location by viewing the proximity-defined game map interface 290. In one embodiment, the GUI displays the safe and/or unsafe flag directly onto the proximity-defined game map interface 290. In one embodiment, the application is operable to filter out safety level submissions from users that are repetitive, unauthentically submitted, or false. In one embodiment, the application is operable to determine the identity of the user profile submitting the safety ranking and determine whether it has submitted a safety ranking for the same location in the past. In this embodiment, the application is operable to remove the subsequent, repetitive submission from plurality of safety ranking submissions.

In one embodiment, the application of the present invention is operable to receive bets or wagers in relation to certain aspects or by the outcome of a recreational activity or sporting event managed through the platform. In one embodiment, the application is operable to allow users to predict a certain event or aspect of a sporting event occurring (e.g., whether a team will score a certain number of points or making a certain number of plays) and place a monetary value on their prediction. In one embodiment, the GUI includes a wager interface. In this embodiment, the wager interface is operable to receive a sporting event prediction and a monetary value. In one embodiment, the prediction is that a certain team will win the recreational activity or sporting event. In one embodiment, the prediction is that a certain team will lose a recreational activity or sporting event. In one embodiment, the prediction is that a certain team will score a specific number of points or goals. In this embodiment, the application is operable to receive the prediction, compare it to other predications for the same event, estimate a probability (based on the plurality of user predictions) of the event occurring, and translate the probability into a monetary value. In one embodiment, the application is operable to forward monetary funds to a financial account associated with the betting user profile upon a predicted outcome occurring and/or being verified. In one embodiment, the application is operable to withdraw monetary funds from a user's account upon a prediction failing and/or being verified to have failed. In one embodiment, a user device receives a notification on the status of their predictions (i.e., whether they were correct or not). In one embodiment, a user device receives a real-time confirmation of a correct prediction and that monetary funds were forwarded into the financial account.

In one embodiment, the application of the present invention is operable to match players, who desire to increase their performance, with coaches willing to train and teach the player. In one embodiment, the application is operable to create a coaching post similar to the host a game post illustrated in FIG. 6. In this embodiment, rather than signing up to participate in a recreational activity or sporting event, the player profile is signing up to be trained in a recreational activity or sporting event. In one embodiment, a coach profile creates a post for player profiles to sign up for to be trained. In one embodiment, a user profile creates a post for a coach to sign up to train the user. In one embodiment, the post created by the coach or by the player includes information pertaining to the coaching session. In one embodiment, the coaching post is displayed on the social media feed 230.

In one embodiment, the GUI associates a ranking with a user of the platform who identifies as a coach (i.e., who has coached a user in the past) and displays the ranking to other users. In this embodiment, following a coaching session between a user and a coach, the platform transmits a prompt to the user device to rank the coach's performance. In this embodiment, the application is operable to receive the user's ranking of the coach's performance and compile the ranking with those derived from other players who have used the coach's services in the past. In this embodiment, the application is operable to display the average ranking on the coach's profile. In one embodiment, the application is operable to cause the GUI of the user device to display a coach's ranking on the coaching post. In one embodiment, the GUI displays a coach's ranking on the proximity-defined game map interface 290. In one embodiment, a user writes a review or comment to associate or explain their ranking of the coach's performance. In one embodiment, a user's review or comment is displayed on the coach's user account.

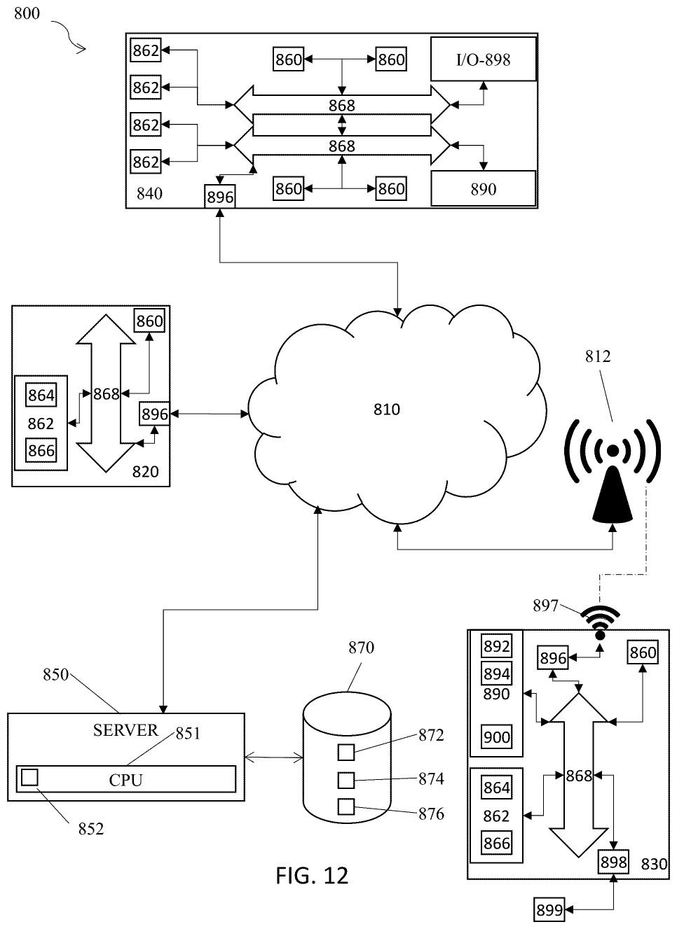

FIG. 12 is a schematic diagram of an embodiment of the invention illustrating a computer system, generally described as 800, having a network 810, a plurality of computing devices 820, 830, 840, a server 850 and a database 870.

The server 850 is constructed, configured and coupled to enable communication over a network 810 with a computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a cloud-based network 810 for distributed communication via a wireless communication antenna 812 and processing by a plurality of mobile communication computing devices 830. In another embodiment of the invention, the system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital computers 820, 840, 850 and mobile devices 830, such as a server, blade server, mainframe, mobile phone, a personal digital assistant (PDA), a smart phone, a desktop computer, a netbook computer, a tablet computer, a workstation, a laptop, and other similar computing devices. The components shown here, their connections and relationships, and their functions, are meant to be exemplary only, and are not meant to limit implementations of the invention described and/or claimed in this document

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers) or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 12, multiple processors 860 and/or multiple buses 868 may be used, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to the bus 868. Computing devices may communicate communication media through wired networks, direct-wired connections or wirelessly such as acoustic, RF or infrared through an antenna 897 in communication with the network antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications or other data embodying any one or more of the methodologies or functions described herein. The computer readable medium may include the memory 862, the processor 860, and/or the storage media 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory or other solid state memory technology, disks or discs (e.g., digital versatile disks (DVD), HD-DVD, BLU-RAY, compact disc (CD), CD-ROM, floppy disc) or other optical storage, magnetic cassettes, magnetic tape, magnetic disk storage or other magnetic storage devices, or any other medium that can be used to store the computer readable instructions and which can be accessed by the computer system 800.

It is also contemplated that the computer system 800 may not include all of the components shown in FIG. 12, may include other components that are not explicitly shown in FIG. 12, or may utilize an architecture completely different than that shown in FIG. 12. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for matching sports event hosts and players, comprising:
a server platform, including a processor and a memory, in network communication with a plurality of user devices;
wherein the server platform is operable to generate user profiles for each user based on inputs from the plurality of user devices, the user profiles including preference data and at least one associated geolocation;
wherein the server platform is operable to update the user profiles with game statistics from previous sporting events;
wherein the server platform is operable to receive commands from one or more event host user profiles to generate one or more sporting events, and wherein each of the one or more sporting events are associated with a geolocation and a time;
wherein the server platform is operable to generate a feed of relevant past and upcoming events for each user profile based on the preference data and the at least one associated geolocation of the user profile, and the geolocation associated with the past and upcoming events;
wherein the server platform includes a query module configured to receive search criteria input from the plurality of user devices and return a list of sporting events relevant to the search criteria input;
wherein the server platform is configured to receive requests from player user profiles to join the one or more sporting events;
wherein the server platform transmits a notification to the one or more event host user profiles regarding the requests to join the one or more sporting events;
wherein the server platform is only able to receive the requests to join the one or more sporting events if the player user profiles meet one or more preestablished requirements associated with the one or more sporting events;
wherein the server platform is operable to generate a map interface on the plurality of user devices, wherein the geolocations associated with the one or more sporting events are visually overlaid on the map interface; and
wherein the server platform includes a wager module, wherein the wager module is operable to receive wager criteria corresponding to one or more wagers relating to the one or more sporting events and automatically generate smart contracts enforcing transfer of funds between two or more wagering user profiles upon when the wager criteria are met.

2. The system of claim 1, wherein the one or more user profiles further include an age, preferred sporting position, and/or gender.

3. The system of claim 1, wherein the server platform is operable to receive commands from one or more coach profiles to generate one or more coaching events, and wherein each of the one or more coaching events are associated with a geolocation and a time.

4. The system of claim 1, wherein the server platform is operable to receive global positioning system (GPS) data directly from GPS modules on the plurality of user devices, and wherein the GPS data is used to generate the at least one associated geolocation for the user profiles.

5. The system of claim 1, wherein the map interface further overlays icons indicating nearby potential players based on the at least one associated geolocation of the user profiles.

6. The system of claim 1, wherein the server platform is operable to receive a preference input by the event host user profiles, designating the one or more sporting events as private, and wherein private sporting events do not appear on the feed of past and upcoming relevant events for other user profiles.

7. The system of claim 1, wherein the server platform includes a leaderboard module configured to show a ranking of user profiles with regard to a particular game and/or a particular game statistic.

8. The system of claim 1, wherein the plurality of user profiles are associated with one or more financial accounts and/or one or more crypto wallets.

9. A method for matching sports event hosts and players, comprising:
a server platform generating user profiles for users based on inputs from a plurality of user devices, the user profiles including preference data and at least one associated geolocation;
the server platform updating user profiles with game statistics from previous sporting events;
the server platform receiving commands from one or more event host user profiles to generate one or more sporting events, and wherein each of the one or more sporting events are associated with a geolocation and a time;
the server platform generating a feed of relevant past and upcoming events for each user profile based on the preference data and the at least one associated geolocation of the user profile, and the geolocation associated with the past and upcoming events;
a query module of the server platform receiving search criteria input from the plurality of user devices and returning a list of sporting events relevant to the search criteria input;
the server platform receiving requests from player user profiles to join the one or more sporting events;
the server platform transmitting notifications to the one or more event host user profiles regarding the requests to join the one or more sporting events;
the server platform receiving the requests to join the one or more sporting events only if the player user profiles meet one or more preestablished requirements associated with the one or more sporting events;
the server platform generating a map interface on the plurality of user devices, wherein the geolocations associated with the one or more sporting events are visually overlaid on the map interface; and
a wager module of the server platform receiving wager criteria corresponding to one or more wagers relating to the one or more sporting events and automatically generating smart contracts enforcing transfer of funds between two or more wagering user profiles upon when the wager criteria are met.

10. The method of claim 9, wherein the one or more user profiles further include an age, preferred sporting position, and/or gender.

11. The method of claim 9, wherein the server platform is operable to receive commands from one or more coach profiles to generate one or more coaching events, and wherein each of the one or more coaching events are associated with a geolocation and a time.

12. The method of claim 9, wherein the server platform receives global positioning system (GPS) data directly from GPS modules on the plurality of user devices, and wherein the GPS data is used to generate the at least one associated geolocation for the user profiles.

13. The method of claim 9, wherein the map interface further overlays icons indicating nearby potential players based on the at least one associated geolocation of the user profiles.

14. The method of claim 9, wherein the server platform receives a preference input by the event host user profiles, designating the one or more sporting events as private, and wherein private sporting events do not appear on the feed of past and upcoming relevant events for other user profiles.

15. The method of claim 9, wherein the server platform includes a leaderboard module configured to show a ranking of user profiles with regard to a particular game and/or a particular game statistic.

16. The method of claim 9, wherein the plurality of user profiles are associated with one or more financial accounts and/or one or more crypto wallets.

17. A system for matching sports event hosts and players, comprising:
a server platform, including a processor and a memory, in network communication with a plurality of user devices;
wherein the server platform is operable to generate user profiles for each user based on inputs from the plurality of user devices, the user profiles including preference data and at least one associated geolocation;
wherein the server platform is operable to update the user profiles with game statistics from previous sporting events;
wherein the server platform is operable to receive commands from one or more event host user profiles to generate one or more sporting events, and wherein each of the one or more sporting events are associated with a geolocation and a time;
wherein the server platform is operable to receive commands from one or more coach profiles to generate one or more coaching events, and wherein each of the one or more coaching events are associated with a geolocation and a time;
wherein the server platform is operable to generate a feed of relevant past and upcoming events for each user profile based on the preference data and the at least one associated geolocation of the user profile, and the geolocation associated with the past and upcoming events;
wherein the server platform includes a query module configured to receive search criteria input from the plurality of user devices and return a list of sporting events relevant to the search criteria input;
wherein the server platform is configured to receive requests from player user profiles to join the one or more sporting events;
wherein the server platform is configured to receive requests from player user profiles to join the one or more coaching events;
wherein the server platform transmits a notification to the one or more event host user profiles regarding the requests to join the one or more sporting events;
wherein the server platform is only able to receive the requests to join the one or more sporting events if the player user profiles meet one or more preestablished requirements associated with the one or more sporting events; and
wherein the server platform is operable to generate a map interface on the plurality of user devices, wherein the geolocations associated with the one or more sporting events are visually overlaid on the map interface.

18. The system of claim 17, wherein the one or more user profiles further include an age, preferred sporting position, and/or gender.

19. The system of claim 17, wherein the map interface further overlays icons indicating nearby potential players based on the at least one associated geolocation of the user profiles.

20. The system of claim 17, wherein the server platform receives global positioning system (GPS) data directly from GPS modules on the plurality of user devices, and wherein the GPS data is used to generate the at least one associated geolocation for the user profiles.
